(19) United States
(12) Patent Application Publication
(10) Pub. No.: US 2025/0291527 A1
(43) Pub. Date: Sep. 18, 2025

(54) METHODS FOR INTEGRATED RESOURCE MANAGEMENT IN A PRINTING SYSTEM

(71) Applicant: Kyocera Document Solutions Inc., Osaka (JP)

(72) Inventors: Javier A. MORALES, Rochester, NY (US); Michelle DE BEUS, Redondo Beach, CA (US)

(73) Assignee: Kyocera Document Solutions Inc., Osaka (JP)

(21) Appl. No.: 18/608,040

(22) Filed: Mar. 18, 2024

(51) Int. Cl. G06F 3/12; G06K 15/00

(52) U.S. Cl. CPC G06F 3/1229; G06F 3/1204; G06K 15/4065

(57) ABSTRACT

Methods for aggregating resources enhance the management of printing resources within a printing system. A shared attribute related to printing operations is used for aggregating a set of papers within a paper catalog used for printing operations at a printing device. Changes to a feature or a printing resource for one or more papers within the aggregated set of papers is managed using the integrated resources. Printing resources include the paper catalog, calibrations, and spot color adjustments. Integrated resource management also occurs across peer calibration groups to update resources.

### FIELD OF THE INVENTION

The present invention relates to a printing device or system for managing printing operations using integrated resource management for the exporting and importing of groups of papers.

### DESCRIPTION OF THE RELATED ART

Accurate color reproduction for production printing requires the use of multiple resources of a digital front end (DFE) of a printing device. These DFE resources include paper catalog entries, calibrations, ICC profiles, and spot color definitions. These resources work in concert with each other to enable the expected color reproduction. Management of these resources and their associations is a complex process that requires time, care, and, most importantly, expertise.

### SUMMARY OF THE INVENTION

A method for managing resources in a printing system is disclosed. The method includes determining a shared attribute related to a printing operation for a plurality of papers in a paper catalog. The method also includes aggregating a set of papers from the plurality of papers within the paper catalog based on the attribute through a user interface. The method also includes modifying the aggregated set of papers according to a type of a printing device. The method also includes editing a feature of the aggregated set of papers using the user interface. The method also includes updating the aggregated set of papers within the paper catalog with the edited feature.

In additional embodiments, the method also may include determining an additional shared attribute within the aggregated set of papers. The method also may include displaying the shared attribute and the additional shared attribute within the user interface. In additional embodiments, the shared attribute may be a printing device specific attribute. In additional embodiments, the modifying the aggregated set of papers may include determining a subset of papers based on the type of printing device. In additional embodiments, the modifying the aggregated set of papers includes determining a subset of papers based on a weight range for the type of printing device. The type of printing device may be a toner printing device. In additional embodiments, the method may include specifying a print ticket setting for a paper within the set of aggregated papers using the attribute. In some embodiments, the printing operation may relate to color reproduction using the plurality of papers.

A method for managing printing resources within a printing system is disclosed. The method includes aggregating a set of papers available for printing on a printing device based on a shared attribute. The method also includes associating a first paper of the set of papers with a paper catalog entry within a paper catalog at the printing device. The method also includes modifying the paper catalog entry for the first paper. The method also includes identifying paper catalog entries within the paper catalog corresponding to the set of papers. The method also includes updating the paper catalog entries for the set of papers with a modification for the paper catalog entry for the first paper.

In additional embodiments, the method may include indicating the modification for the paper catalog entries within a user interface. In additional embodiments, the modifying the paper catalog entry for the first paper may include adding a color printing resource. The color printing resource may be a calibration for the first paper. The calibration may include measurement data. In some embodiments, the method may include sharing the measurement data for the calibration with the paper catalog entries of the set of papers. In additional embodiments, the method may include setting an alert for the paper catalog entries of the set of papers based on the modification of the paper catalog entry for the first paper.

A method for managing printing resources for a printing device is disclosed. The method includes determining an attribute for a first paper in a paper catalog of the printing device. The method also includes forming a set of papers having the first paper and the attribute. The method also includes determining at least one additional paper within the paper catalog having the attribute. The method also includes adding the at least one additional paper to the set of papers. The method also includes setting a combination of additional attributes for the first paper and the at least one additional papers of the set of papers. The method also includes forming a subset of the set of papers having the combination of additional attributes. The method also includes indicating a status for each paper in the subset of papers.

In additional embodiments, the method may include editing a feature of the first paper of the set of papers. The method also may include updating the set of papers with the edited feature. In additional embodiments, the method may include determining a color printing resource within a paper catalog entry for the first paper in the paper catalog. In some embodiments, the method may include updating the color printing resource in the paper catalog entry for the first paper. In some embodiments, the method may include indicating the updated color printing resource for the first paper.

A method for managing color printing resources within a printing system is disclosed. The method includes determining a shared attribute related to color reproduction of a plurality of papers in a paper catalog. The method also includes aggregating a set of papers from the plurality of papers within the paper catalog based on the attribute through a user interface. The method also includes selecting a first paper of the set of papers. The first paper is calibrated by an earlier calibration. The method also includes performing a new calibration using the first paper. The method also includes updating the set of papers having the first paper with the new calibration.

In additional embodiments, the updating the set of papers may include replacing an existing calibration for each of the set of papers. In additional embodiments, the method may includes determining the first paper is not available for the new calibration. The method also may include selecting a second paper of the set of papers for the new calibration. The method also may include updating the set of papers having the first paper and the second paper with the new calibration.

In additional embodiments, the method may include deleting an existing calibration for a selected paper of the set of papers. The selected paper may be within the paper catalog. The method also may include deleting an ICC profile associated with the existing calibration for the selected paper from the paper catalog.

In additional embodiments, the method may include determining that the new calibration failed. The method also may include updating a status for an ICC profile associated with a selected paper of the set of paper that the ICC profile is invalid.

In additional embodiments, the method may include replacing an existing calibration for a selected paper within the set of papers with the new calibration. The selected paper may be associated with an ICC profile. The method also may include comparing the existing calibration with the new calibration. Based on the comparison, the method also may include remapping an association between the ICC profile to use the new calibration. The method also may include updating a status for the ICC profile to include a warning to recreate the ICC profile or, alternatively, deleting the ICC profile.

The first paper may include a spot color adjustment. In some embodiments, the method may include preventing updating a selected paper of the set of papers with the new calibration if the selected paper does not have the spot color adjustment.

In additional embodiments, the method may include deleting an existing calibration for a selected paper within the set of papers. The method also may include deleting a spot color adjustment associated with the existing calibration for the selected paper. In additional embodiments, the method may include determining that the new calibration failed. The method also may include updating a status for a spot color adjustment associated with the selected paper of the set of papers that the spot color adjustment is invalid.

In additional embodiments, the method may include replacing an existing calibration for a selected paper within the set of papers with the new calibration. The paper may be associated with a spot color adjustment. The method also may include comparing the existing calibration with the new calibration. Based on the comparison, the method also may include remapping an association between the spot color adjustment and the new calibration. The method also may include updating a status for the spot color adjustment to include a warning to readjust the spot color adjustment, or, alternatively, deleting the spot color adjustment.

A method for managing color printing resources is disclosed. The method includes determining a shared attribute related to color reproduction of a plurality of papers in a paper catalog. The method also includes aggregating a set of papers from the plurality of papers within the paper catalog based on the attribute through a user interface. The method also includes selecting a first paper of the set of papers. The first paper is calibrated by an earlier calibration. The method also includes performing a new calibration using the first paper. The method also includes updating at least one paper of the set of papers having the first paper with the new calibration. The method also includes deleting an existing calibration for a selected paper of the set of papers. The selected paper is within the paper catalog.

In additional embodiments, the method may include deleting an ICC profile associated with the existing calibration for the selected paper from the paper catalog. In some embodiments, the updating at least one paper of the set of papers may include updating at least one paper having a print condition of the first paper. In some embodiments, the updating at least one paper of the set of papers may include updating at least one paper in a project with the first paper.

In additional embodiments, the method may include modifying a setting for the first paper of the set of papers. In some embodiments, the method also may include updating the setting for each paper of the set of papers. In additional embodiments, the method may include providing a warning for each paper of the set of papers that the existing calibration is deleted.

A method for managing printing operations is disclosed. The method includes determining a shared attribute for a plurality of papers available for printing at a printing device. The method also includes aggregating a set of papers from the plurality of papers based on the shared attribute. The method also includes receiving a print job at the printing device. The print job specifies a first paper of the set of papers. The method also includes determining a color printing resource is not available at the printing device. The method also includes determining a second paper of the set of papers has the color printing resource. The method also includes indicating the second paper is available for the print job along with indicating the color printing resource.

In some embodiments, the color resource may be a calibration, a paper catalog entry, an ICC profile, or a spot color adjustment.

A method for managing printing operations is disclosed. The method includes determining an attribute for a first paper of a plurality of papers available to print at a printing device. The first paper includes a calibration having calibration source data as a printing resource. The method also includes determining the first paper is in a peer calibration group based on the calibration. A plurality of papers in the peer calibration group use a plurality of calibrations having the calibration source data. The method also includes editing a feature of the first paper of the peer calibration group using a user interface. The method also includes updating the plurality of papers within the peer calibration group with the edited feature.

In additional embodiments, the method may include deleting the calibration for the first paper. The method also may include deleting an ICC profile associated with the calibration.

In additional embodiments, the method may include deleting an existing calibration for a selected paper within the peer calibration group. The method also may include providing a notification within the peer calibration group that the existing calibration is deleted. In some embodiments, the method also may include updating a status for an ICC profile associated with the existing calibration for the selected paper that the ICC profile is invalid.

In additional embodiments, the method may include performing a recalibration for the first paper. In some embodiments, the method also may include replacing at least one peer calibration for at least one paper of the plurality of papers of the peer calibration group based on the recalibration. In additional embodiments, the feature of the first paper may be another attribute. In additional embodiments, the method may include aggregating a set of papers of the plurality of papers within the peer calibration group based on the attribute.

A method for managing printing operations is disclosed. The method includes determining an attribute for a first paper of a plurality of papers available to print at a printing device. The first paper includes a calibration having calibration source data as a printing resource. The method also includes determining the first paper is in a peer calibration group based on the calibration. A plurality of papers in the peer calibration group use a plurality of calibrations having the calibration source data. The method also includes determining the calibration fails a quality check at the printing device. The method also includes providing a notification of a warning status for calibrations of the plurality of papers with the peer calibration group.

In additional embodiments, the method may include propagating the warning status to an ICC profile linked to the calibration of the plurality of papers. In additional embodiments, the method may include performing a recalibration of the first paper. The first paper may pass the quality check with the recalibration using new calibration source data. In some embodiments, the method also may include clearing the warning status from a subset of the plurality of papers. The calibrations of the subset of papers have lower tone reproduction curve (TRC) values than TRC values for the calibration for the first paper. In some embodiments, the method may include clearing the warning status for the first paper.

A method for managing printing operations is disclosed. The method includes determining an attribute for a first paper of a plurality of papers available to print at a printing device. The first paper includes a calibration as a printing resource. The method also includes aggregating a set of papers from the plurality of papers based on the attribute through a user interface. The method also includes determining a spot color associated with the calibration. The spot color is printable at the printing device. The method also includes making a spot color adjustment for the spot color. The method also includes updating the spot color for the set of papers to be printed at the printing device with the spot color adjustment.

In additional embodiments, the aggregating the set of papers may include aggregating according to a print condition for the set of papers. In additional embodiments, the aggregating the set of papers may include aggregating according to a project using the set of papers. In additional embodiments, the aggregating the set of papers may include aggregating according to a customer identification that uses the set of papers at the printing device. In additional embodiments, the method may include printing a document at the printing device using a selected paper from the set of papers. The selected paper implements the spot color adjustment for the spot color. In additional embodiments, the method may include generating the spot color adjustment when the calibration is generated for the first paper.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Various other features and attendant advantages of the present invention will be more fully appreciated when considered in conjunction with the accompanying drawings.

FIG. 1A illustrates a printing system having a printing device for printing documents according to the disclosed embodiments.

FIG. 1B illustrates a digital front end (DFE) for a printing device according to the disclosed embodiments.

FIG. 2 illustrates a block diagram of components of the printing device for use within the printing system according to the disclosed embodiments.

FIG. 3 illustrates a block diagram of a paper catalog for use within the printing system according to the disclosed embodiments.

FIG. 4 illustrates a block diagram of aggregated sets of papers based on an attribute or a resource of a first paper according to the disclosed embodiments.

FIG. 5A illustrates an example listing of attributes for a specific paper, or the first paper, according to the disclosed embodiments.

FIG. 5B illustrates an example listing of paper group attributes for a set of papers generated according to the disclosed embodiments.

FIG. 6 illustrates a flowchart for aggregating related resources based on a paper catalog entry according to the disclosed embodiments.

FIG. 7 illustrates a flowchart for aggregating related resources based on a calibration according to the disclosed embodiments.

FIG. 8 illustrates a flowchart for aggregating related resources based on an ICC profile according to the disclosed embodiments.

FIG. 9 illustrates a flowchart for aggregating resources according to the disclosed embodiments.

FIG. 10 illustrates a flowchart for managing a first set of papers using an attribute according to the disclosed embodiments.

FIG. 11 illustrates a flowchart for managing the first set of papers using a paper catalog entry according to the disclosed embodiments.

FIG. 12 illustrates a flowchart for managing a subset of papers having additional attributes according to the disclosed embodiments.

FIG. 13 illustrates a flowchart for managing color printing resources within the printing system according to the disclosed embodiments.

FIG. 14 illustrates a flowchart for using integrated resources to determine a second paper for printing operations according to the disclosed embodiments.

FIG. 15 illustrates a flowchart for integrated resource management using peer calibration groups according to the disclosed embodiments.

FIG. 16 illustrates a flowchart for handling a failed calibration for a paper within a peer calibration group according to the disclosed embodiments.

FIG. 17 illustrates a flowchart for integrated resource management based on a spot color adjustment according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a system in which digital front end (DFE) resources, such as paper definitions, calibrations, ICC profiles, and spot colors, are managed as an integrated whole. This feature also includes appearance adjustments.

Instead of managing paper catalog entries as individual items, the disclosed embodiments aggregate papers based on attributes that impact color reproduction. This feature is in contrast to managing paper catalog entries as substrates, which may be a collection of papers that differ only in their dimensions and grain. This aggregation may enable collective management of papers that have different values for many different attributes, and not just size.

For example, papers may have different weights, number, and type of drilling, number, size of tabs, and the like. This aggregation automatically would change depending on the printing device type. In further example, all papers of any weight may be aggregated for an inkjet printing device as inkjet printing devices generally deposit ink atop of the paper. Papers for a toner printing device may be aggregated based on weight ranges as these correspond with fuser temperature or paper transport speed, both of which impact color reproduction.

Papers may be managed at the aggregated level so all shared attributes are defined once. Alternatively, papers may be aggregated at the product level and the system automatically may divide the paper definition into groups based on printer-specific attributes. For example, for a toner printing device, a paper may be divided into multiple weight ranges that correspond to paper transport speed settings. This aggregation may be used when managing the paper catalog and also when specifying print ticket settings. Unlike systems that aggregate papers, the disclosed aggregation is done in concert with the DFE's color management so that papers automatically are managed as groups using varying granularity that is specific to the characteristics of the printing device.

The disclosed embodiments also allows the operator to select a paper for calibration. Unlike current implementations, however, the calibration would be aware of the paper catalog. Specifically, it would be aware of the paper catalog aggregation. As such, the disclosed embodiments may present a single selection of papers for all of the aggregated papers. The operator calibrates using that paper. This calibration is automatically shared between all aggregated papers. The disclosed embodiments may give the operator the option to use another paper within the aggregated group for calibration. If the operator does this, however, the disclosed embodiments may automatically replace any existing calibrations so that there is exactly one calibration for each aggregated group of papers.

This approach may eliminate manual association between papers and calibrations because the calibration understands the paper aggregation. The disclosed embodiments may manage calibrations so it is not possible for the operator to misconfigure the system.

The calibration operations are themselves managed collectively so that the system does not allow the operator to select an uncalibrated paper to perform operations that depend on calibrations. This feature applies to quality check, recalibration, and match calibration operations. The disclosed embodiments may prevent operator errors in one of two ways. First, the disclosed embodiments only may present calibrated papers to the user so that it is impossible for the operator to perform one of these operations on a uncalibrated paper. Alternatively, the disclosed embodiments may not give the operator the ability to specify a paper. Instead, the disclosed embodiments may present a list of calibrations to the operator. Once a calibration is selected, the disclosed embodiments apply the correct paper settings.

The disclosed embodiments also allows the operator to profile papers. Unlike current implementations, however, the ICC profiling is aware of calibrations and of the paper catalog. Specifically, it is aware of the paper catalog aggregation. As such, the disclosed embodiments may prevent paper selection errors in ICC profile creation in the same manner as it does for other calibration-dependent operations. In addition, the disclosed embodiments manage calibrations and ICC profiles as a unit. As such, ICC profiles are automatically deleted when calibrations are deleted. If recalibration fails, then the ICC profile statuses are updated to reflect the fact that an invalid calibration means that the ICC profile also is invalid.

If the operator replaces a calibration for a paper group, the disclosed embodiments may remap the association between ICC profiles and calibrations to use the new calibration. Alternatively, the disclosed embodiments may update the ICC profile status to a warning to let the operator know that the ICC profile should be recreated. In some embodiments, the disclosed embodiments may remove the ICC profile. The disclosed embodiments also may compare the new and replaced calibration to determine which of the above operations makes sense.

For example, if the new calibration is substantially similar, then remapping would make sense. If the new calibration is not substantially similar but it is within a certain threshold of the previous calibration then perhaps a warning status would make sense. If the new calibration is very different versus the previous one, then perhaps removal of the ICC profile would make sense.

Although spot color definitions are global, print shops often adjust spot color appearance for specific papers. It may be up to the customer to either choose or enable/disable these alternate spot color definitions.

In the disclosed embodiments, the spot color adjustments are aware of both calibrations and of the paper catalog. Specifically, they are aware of the paper catalog aggregation. As such, the disclosed embodiments prevent paper selection errors in spot color adjustment definitions as it does for other calibration-dependent operations. In addition, the disclosed embodiments manage calibrations and spot color adjustments as a unit. As such, spot color adjustments are automatically deleted when calibrations are deleted. If recalibration fails, spot color adjustments are updated to reflect the fact that an invalid calibration means that the spot color adjustments also are invalid.

If the operator replaces a calibration for a paper group, the disclosed embodiments may remap the association between spot color adjustments and calibrations to use the new calibration. Alternatively, the disclosed embodiments may update the spot color adjustments status to a warning to let the operator know that the spot color adjustments should be readjusted. The disclosed embodiments also may remove the spot color adjustments.

The disclosed embodiments also may compare the new and the replaced calibration to determine which of the above operations makes sense. For example, if the new calibration is substantially similar then remapping would make sense. If the new calibration is not substantially similar but it is within a certain threshold of the previous calibration, then perhaps a warning status would make sense. If the new calibration is very different versus the previous one, then perhaps removal of the spot color adjustments would make sense.

Thus, the disclosed embodiments enable integrated management of what are normally disparate resources in a DFE. These features prevent operator error while making it easy for the operator to define and use the color management resources that are needed for production print color reproduction.

For calibrations, the disclosed embodiments may mirror the aggregation used to manager calibrations and display a single entry for each “peer calibration” group. Peer calibration groups use calibrations that share the same source calibration data. These calibrations are printed using the same values for attributes that affect calibration curves, such as media and halftones. For ICC profiles and spot colors, the disclosed embodiments may mirror aggregation used to manage spot colors and ICC profiles, and displayed aggregated spot color definitions.

For calibrations, the disclosed embodiments may look for the paper catalog entry that was used to create the calibration. The disclosed embodiments then may determine which papers should be aggregated together with the calibrated paper and display those as an aggregated entry to the operator. The disclosed embodiments may look for ICC profiles that are associated with the calibration and display those to the operator. The disclosed embodiments also may look for spot color adjustments that are associated with the selected calibration. The disclosed embodiments may determine which base spot color definition and spot color aliases should be aggregated together with the spot color adjustment definition to display these as an aggregated entry to the operator.

For ICC profiles, the disclosed embodiments may look for the calibration that was used to create the ICC profile. The disclosed embodiments then may determine which calibrations are part of a “peer calibration” group and display those as an aggregated entry to the operator. For spot colors, the disclosed embodiments may look for spot color aliases and spot color adjustments that are associated with the selected spot color. The disclosed embodiments may display those to the operator as an aggregated entry.

The disclosed embodiments also may crawl through resources to provide the operator with a complete set of resources. For example, if the operator exports the paper catalog, the disclosed embodiments may display multiple paper catalog entries as a single aggregated entry. The disclosed embodiments then may determine if any of the aggregated entries have been calibrated. If a paper catalog entry has been calibrated, then the disclosed embodiments will aggregate all of the calibrations for the paper catalog entry. There may be multiple peer calibration groups for a given paper catalog entry.

The disclosed embodiments then may determine if an ICC profile has been created for any of the calibrations. If so, then the disclosed embodiments may display the ICC profiles. The disclosed embodiments also may determine if there are any spot color adjustments associated with any of the selected calibrations. If so, then the disclosed embodiments may display the base spot color definition and spot color aliases associated with the spot color adjustment. The disclosed embodiments optionally may export spot color adjustments that are associated with paper catalog entries other than the selected paper catalog entry. If those adjustments are exported then the disclosed embodiments will crawl back through resources and display those additional calibrations, paper catalog entries, and ICC profiles.

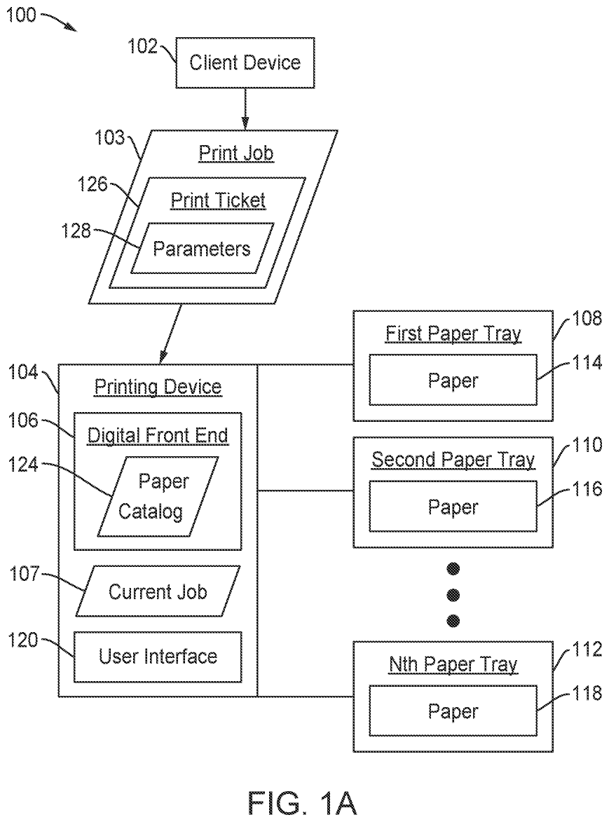

FIG. 1A depicts a printing system 100 for printing documents according to the disclosed embodiments. Printing system 100 includes printing device 104. Printing device 104 is disclosed in greater detail below. Printing device 104 may receive one or more print jobs 103 within printing system 100. For example, client device 102 may generate and send print job 103 to printing device 104. In some embodiments, printing device 104 may be a production printing device in that print jobs are provided through client device 102, which is attached to the printing device. Such a print job may require 1000 s of pages or even 100,000 pages or more.

Print job 103 may include a print ticket 126 that sets forth one or more parameters 128 for the print job. For example, print ticket 126 may specify a size for a sheet of print job 103 as well as weight, quality of paper, color of paper, punched holes, and the like. The operator may generate print ticket 126 when submitting print job 103 for printing within printing system 100. Information from print ticket 126, such as one or more parameters 128, may be used to generate a list of recommended papers to display for print job 103.

Printing device 104 may receive print job 103 as it is processing and printing current job 107. Current job 107 may use different paper or media than print job 103. As such, printing device 104 may include a plurality of paper trays to supply papers of various types, sizes, weights, and the like. Thus, printing device 104 includes first paper tray 108 having paper 114, second paper tray 110 having paper 116, and so on to Nth paper tray 112 having paper 118. Current job 107 may use paper from one or more of these paper trays. In some embodiments, paper 114, paper 116, and paper 118 are different types of paper or different media. For example, current job 107 may use paper 116 from second paper tray 110 while print job 103 may require paper 114 from first paper tray 108.

User interface 120 may be in operation panel 208, disclosed below, or part of digital front end (DFE) 106. DFE 106 is disclosed in greater detail below. DFE 106 may process print jobs and act as a controller for printing device 104. Alternatively, user interface 120 may be displayed on client device 102. The disclosed embodiments may use user interface 120 to select papers for print job 103.

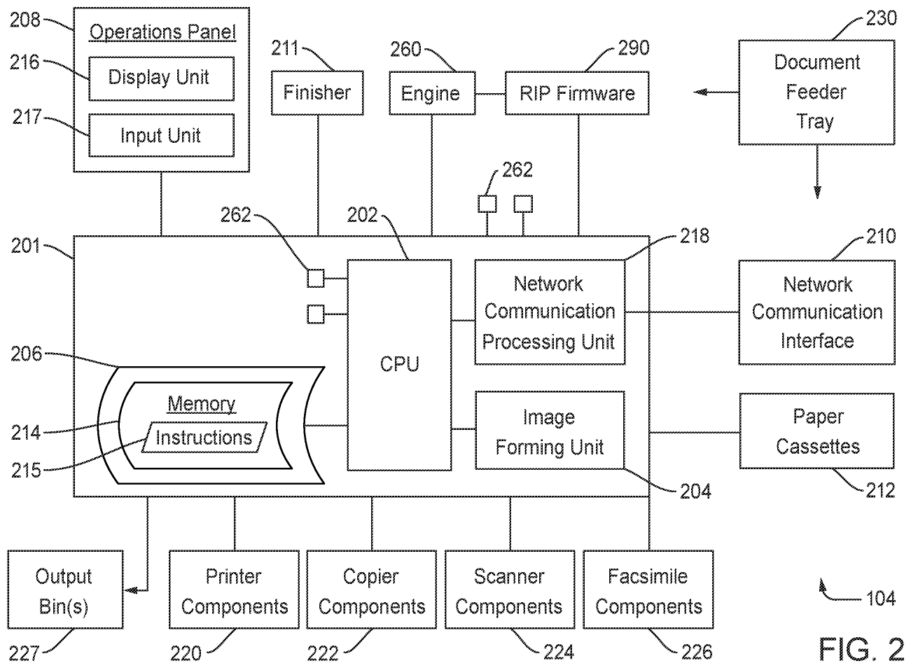

DFE 106 also includes paper catalog 124. Paper catalog 124 is configured to organize and store existing calibration data and ICC profiles for a plurality of papers. Upon selection of a paper for printing at printing device, paper catalog 124 may be accessed to complete print job 103 according to the expectations associated with the print job. Paper catalog 124 is disclosed in greater detail below by FIG. 3. In some embodiments, DFE 106 may include multiple paper catalogs. Further, paper catalog 124 also may be stored in another component within printing system 100 and accessible by DFE 106.

FIG. 1B depicts a block diagram of DFE 106 according to the disclosed embodiments. DFE 106 includes a receiver 181, a RIP firmware 290, a CMYK data storage 184, an input/output connector 185, and a correcting unit 186. Additional components within DFE 106 may be implemented, as disclosed above and below.

Receiver 181 receives print job 103 received within system 100 and outputs the print job to RIP firmware 290. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When print color provided alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 may be transmitted within printing system 100 via input/output connector 185. The print condition information and the print medium type, as well as the rendering data, may be transmitted to a selected printing device within printing system 100. As disclosed above, the rendered data may be in a file format acceptable for a printing device such that the print job is provided directly to the print engine of the printing device.

DFE 106 also includes web user interface 188 that may communicate with other devices within printing system 100, if it is located at a separate device, using, for example, input/output connector 185. Web user interface 188, or web application, allows a user of the DFEs of other printing devices to interact with content or software running on DFE 106.

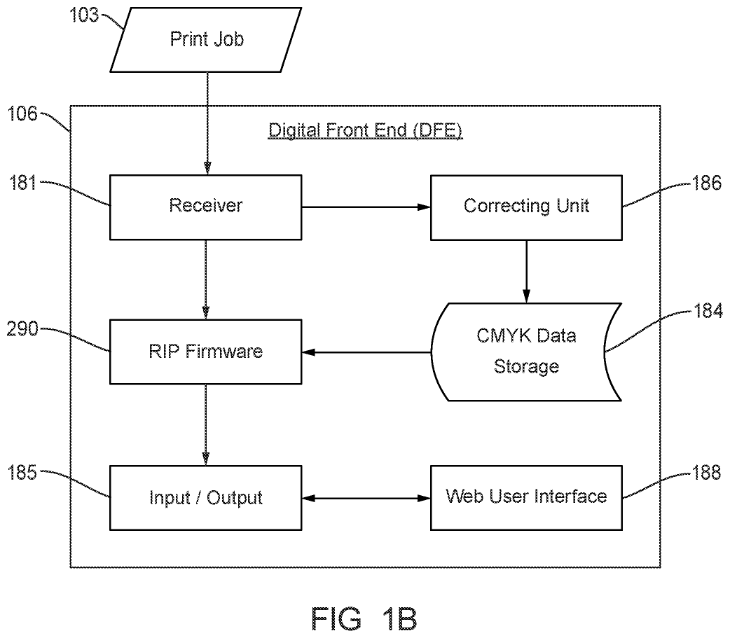

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within system 100. As disclosed above, printing device 104 may send and receive data from DFE 106 and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays, shown as paper trays 108, 110, and 112 in FIG. 1A. Paper cassettes 212 may include papers having various sizes, colors, composition, and the like. Papers or media within paper cassettes 212 may be considered “loaded” onto printing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from DFE 106, if applicable. DFE 106 may send calibration and paper catalog information to printing device 104 for display. For example, the operator at DFE 106 may send a calibration to printing device 104. Printing device 104 displays paper type and any other information needed to complete the calibration.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on printing device 104.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device. Memory unit 206 may store the history of failure events and occurred errors with a timestamp of each error.

Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from DFE 106 as well as other devices within system 100.

FIG. 3 depicts a block diagram of paper catalog 124 for use within printing system 100 according to the disclosed embodiments. As disclosed above, paper catalog 124 may reside within DFE 106 of printing device 104. In other embodiments, paper catalog 124 may reside in another component within printing system 100, such as client device 102 or an external server. For brevity, paper catalog 124 is disclosed below as residing within DFE 106.

For each paper type used for a particular model of printing device 104, there are a set of items that work together to achieve optimal reproduction capabilities. These items may be represented in paper catalog 124. An example of an entry in paper catalog for a paper type 302 may be shown. Paper catalog may include hundreds or thousands of such entries. Paper type 302 may be identified within paper catalog 124 by paper type identification 303. In some embodiments, paper type identification 303 may be a unique symbol or code that identifies paper type 302 within paper groups, disclosed in greater detail below.

Paper type 302 includes print conditions. Print conditions may be applied to print jobs using paper type 302. Examples of print conditions may be high quality, default, ink saving, and the like. Each print condition may include its own color printing resources, such as calibration data and ICC profiles. Application of a print condition results in a different result for a print job using paper type 302 at printing device 104. For example, a high quality print condition will differ in some fashion as a finished, printed document from one printed using the default print condition.

As shown in FIG. 3, paper type 302 may include print condition 304. It also may include additional print conditions. Print condition 304 may relate to the high quality print condition for printing paper type 302 at printing device 104. Within print condition, halftones, or halftone designs, may be defined. Printing device 104 may have one or more halftones. Halftones are binary on/off dot patterns of each ink to mimic continuously varying transitions. One halftone could emphasize details in the image, while another could be best for smooth transitions. Thus, print condition 304 includes halftone 306A and halftone 306B. For example, halftone 306A may correspond to the halftone design to emphasize details in the image being printed. Halftone 306B may correspond to the halftone design to provide for smooth transitions.

For each halftone, the print shop should capture the desired per-colorant behavior over all shades of that colorant. By behavior, the disclosed embodiments refer to the color measurement. The record of these colorant behaviors, and the information that allows printing device 104 to be adjusted back to such behaviors, are stored as calibration data. These adjustments may vary linearly or with a curve. The calibration data include characteristics of each ink under the halftone selected. Thus, halftone 306A includes calibration data 308A and halftone 306B includes calibration data 308B.

Further, with a selected halftone, and the calibration data enforced to produce desired behavior of each colorant, the disclosed embodiments then create an ICC profile to fully characterize how ink combinations relate to standardized color measurements, as disclosed above. It is via the ICC profile that, for the specific paper-halftone-calibration-data set up, printing device 104 can reproduce the colors, text, and parameters of the original document. The process for generating an ICC profile is disclosed above. Thus, halftone 306A includes ICC profile 310A and halftone 306B includes ICC profile 310B.

Often printing systems have additional “dials” for more customized controls. For instance, there are settings of total ink amounts allowed in the ICC profile for preserving the glossy finish of a paper. Alternatively, it could be a very conservative expectation of the black ink response set into the calibration data. These more specific customizations may be identified as print conditions. In the scheme of the aforementioned items affecting color management, the disclosed embodiments place print conditions at the highest tier under each paper type, as shown in FIG. 3 by print condition 304.

Paper type 302 along with print condition 304 and halftones 306A and 306B may refer to the print management resources and items for one paper type. In a print shop, for each model of printing device 104, there may be dozens or more paper types in use. To keep track of the print management items for all these papers, paper catalog 124 may be implemented in system 100. As disclosed above, paper catalog 124 may be a software data storage system that archives all the color management items and resources for each paper type in use. When a print job is specified on a particular paper, identified as paper type identification 303, under a chosen print condition 302 employing halftone 306A, paper catalog 124 will provide the proper corresponding calibration data 308A and ICC profile 310A for printing device 104 to use. If the print job specifies print condition 302 employing halftone 306B, then paper catalog 124 will provide calibration data 308B and ICC profile 310B for printing device 104 to use for the print job.

Paper type 302 also may include one or more attributes for the paper. For example, first attribute 312 may be the weight of a sheet of paper type 302. First attribute 312 may be 120 grams per square meter (gsm). Heavier paper is reflected by a higher number for gsm. Generally, heavier paper is associated with a higher quality of stock. It should be noted that dimensions may also be considered an attribute of paper type 302. Further, first attribute 312 may be considered a dimension of paper type 302.

Paper type 302 also may include second attribute 314 and third attribute 316. These attributes may pertain some other feature of the paper of paper type 302 aside from dimensions and weight. Second attribute 314 may refer to the color of the paper for paper type 302, such as white, blue, yellow, and the like. Third attribute 316 may refer to a feature of the paper of paper type 302, such as recycled, new, and the like. Other potential attributes may be glossy or matte paper.

Dimensions and attributes within paper catalog 124 may not necessarily match the attributes for paper trays 108, 110, and 112. Paper trays 108, 110, and 112 also may have attributes that apply to print job 103 as specified by print ticket 126. Dimensions may be included in print ticket 126. Dimensions also may apply to a parameter within paper catalog 124 and paper trays 108, 110, and 112. The other attributes, however, within paper catalog 124 may not apply to any attribute for paper trays 108, 110, and 112.

In some embodiments, calibrations and ICC profiles may be listed in a paper catalog entry 302 but not associated with a print condition. Further, additional print conditions may be listed for each entry. In other words, the print condition may be null within paper catalog entry 302. For example, paper catalog entry 302 may include print condition 304 as disclosed above. It also may include another set of calibration and ICC profile data, such as calibration 308A or 308B and ICC profile 310A or 310B, that is not associated with a print condition.

Paper catalog entry 302 also may include a second print condition that uses a different calibration but perhaps the same ICC profile as the sets not corresponding to a print condition. Further, paper catalog entry 302 may include another group of printing resources for halftone 306B but this is not related to a print condition and includes its own calibration and ICC profile. In other words, printing resources may be listed in a paper catalog entry 302 in a number of ways. Multiple calibrations and ICC profiles may be tied to an entry. The calibration and ICC profiles may still be tied to the integrated resource management operations disclosed herein.

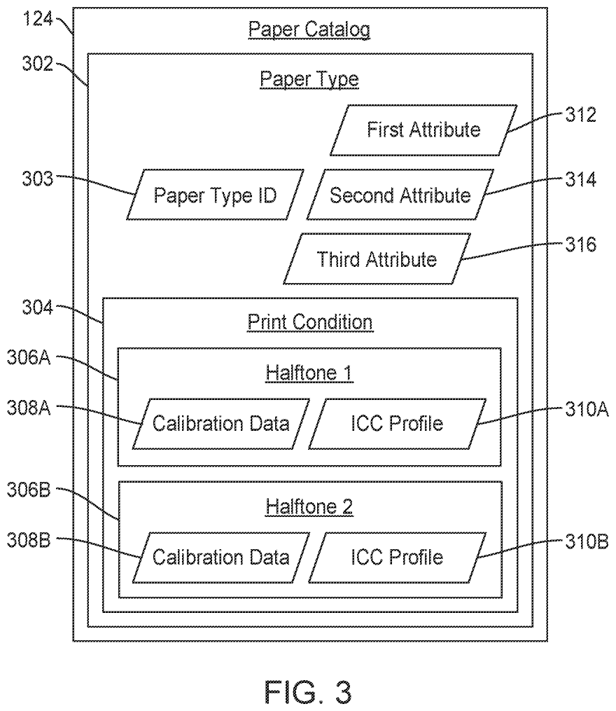

FIG. 4 depicts a block diagram of aggregated sets of papers based on an attribute 404 or a resource of a first paper 402 according to the disclosed embodiments. The disclosed embodiments allow for the management of integrated resources using the aggregated sets of papers. When a resource is modified, changed, or used in some manner, such as from paper catalog 124, all linked resources also are managed to reflect the modification, change, or use. An operator would not need to manage the correlation between resources as it is done automatically by DFE 106, which includes many of the resources and paper catalog 124 for a printing device. The embodiments disclosed below may refer only to managing resources or data applicable to printing device 104 but these same embodiments may be used to manage resources or data to within printing system 100.

It should be noted that the integrated resources are not represented in paper catalog 124 but they may operate as if they are a paper catalog. Aggregated sets of papers based on one or more attributes may be managed outside paper catalog 124 for printing operations, including management of printing resources for the papers.

When an operator chooses to manage a resource of a given type, DFE 106 may determine whether any aggregation of papers within paper catalog 124 makes sense. The aggregations may be generated based on a resource used to print a first paper 402. First paper 402 may refer to a paper catalog entry 302 in paper catalog 124 for a paper or media type available for printing at printing device 104. First paper 402 may be loaded as paper 114, 116, or 118 at printing device 104. Alternatively, first paper 402 may not be loaded at all.

First paper 402 may include attributes or resources set forth in its paper catalog entry 302. For brevity, attribute 404 is shown in FIG. 4. Attribute 404 may refer to first attribute 312, second attribute 314, or third attribute 316 for first paper 402. Any of these attributes may be used as attribute 404 by DFE 106 to generate first set of papers 416. Further, attribute 404 may include a value 406 that specifies a feature of the attribute. Examples of attributes and values are disclosed in greater detail below. First set of papers 416 is generated from the plurality of paper catalog entries 302 within paper catalog 124.

For example, first set of papers 416 may include second paper 418 and third paper 420. Second paper 418 and third paper 420 correspond to paper catalog entries 302 in paper catalog 124 for different papers that have attribute 404 of first paper 402. More than one attribute 404 for first paper 402 may be used in generating first set of papers 416. For example, if attribute 402 is paper size, or dimensions, then second paper 418 and third paper 420 include attribute 402 as having the same paper size as first paper 402. If first set of papers 416 is exported, then those papers having the same size as first paper 402 also will be exported.

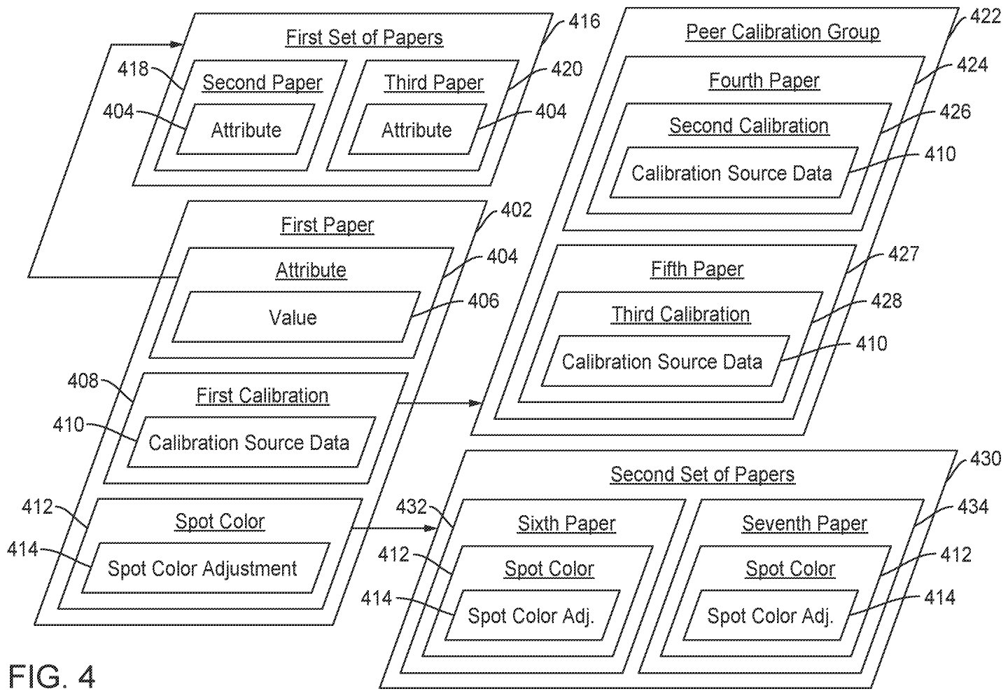

These features may be disclosed in greater detail by FIGS. 5A and 5B. FIG. 5A depicts an example listing of attributes 502 for a specific paper, or first paper 402, according to the disclosed embodiments. FIG. 5B depicts an example listing of paper group attributes for a set of papers generated according to the disclosed embodiments. Attributes 502 of FIG. 5A refer to attribute 404 in FIG. 4. For example, attribute 404 may be any one of attributes 502 for first paper 402. Attributes 502 may be listed in paper catalog entry 302 for first paper 402, or may be a file associated with first paper 402. FIG. 5A may show how attributes 502 are displayed for first paper 402 in user interface 120. For example, an operator may click on an entry for first paper 402 within user interface 120 to display its attributes 502.

Name attribute 504 may refer to the name given for first paper 402 in paper catalog 124, at printing device 104, or within printing system 100. Value 506 may be a field with the name, such as First Paper for first paper 402. External identification attribute 508 may refer to an external identification number or code for the paper. Value 510 may be a field with the code. Here, the code may be 62e26558-a3e9. Brand attribute 512 may be the brand name for first paper 402. Many paper manufacturers have their own names for their papers. For example, Big Print Company may make first paper 402 with a brand name of Big Print Color Copy. Thus, value 514 may be a field having Big Print Color Copy.

Size attribute 516 may refer to the size of the paper. Size attribute 516 may correspond to dimensions of the paper. Value 518 may be A4, which is a common reference to a paper size used in printing operations. Other data for value 518 may be letter, legal, A3, or A5. Value 518 also may include the actual dimensions, or 210 mm by 297 mm.

Feed direction attribute 520 may refer to the direction that first paper 402 is fed within printing device 104. Value 522 may include long edge as the feed direction. Weight attribute 524 may refer to the weight of first paper 402. Value 526 may be the weight in grams per square meter, or gsm. Here, value 526 is 170 gsm. Grain attribute 528 may refer to the grain used by first paper 402. Value 530 may be, for example, long for a long grain.

Type attribute 532 may refer to the paper type for first paper 402. Value 534, for example, may be plain in that first paper 402 is a plain type. Set count attribute 536 may refer to the set count used for first paper 402. Value 538, for example, may be 1. Color attribute 540 may refer to the color of first paper 402. Value 542, for example, may be white in that first paper 402 is white.

Front coating attribute 544 may refer to the coating of the front of first paper 402. Value 546, for example, may be inkjet, as opposed to toner or laser, to indicate that first paper 402 is to be used in inkjet printing devices. Back coating attribute 548 may refer to the coating of the back of first paper 402. Value 550, for example, also may be inkjet. Texture attribute 552 may refer to the texture, or feel, of first paper 402. Value 554, for example, may be smooth to indicate that first paper 402 has a smooth texture. Preprinted attribute 556 may refer to whether first paper 402 is preprinted before being loaded onto printing device 104. Value 558, for example, is no.

Paper group name 560 may refer to a paper group that includes first paper 402. The paper group may be generated using one or more attributes 502 in papers within paper catalog 124. Not every paper within the paper group may have all the attributes of first paper 402. Here, value 562 for the paper group name may be coated glossy. The coated glossy paper group may be made available to the operator via user interface 120 for selection to export or import. If first paper 402 is selected to export, then the disclosed embodiments also provide first set of papers 416, or coated glossy, for selection to export. In some embodiments paper group name 560 may be an attribute.

FIG. 5B depicts an example of a first set of papers 416 as a paper group having paper group name 560. This information may be shown as paper group attributes 570 for first set of papers 416 displayed to the operator in user interface 120 if first set of papers 416 is selected or click on in the interface to display more information. Paper group attributes 570 include attributes corresponding to attributes 502 for first paper 402. Paper group attributes 570, however, does not include all attributes 502 as the paper group preferably includes a plurality of papers.

Paper group attributes 570 includes paper group name 560 which has a value 562 of coated glossy. Paper group name 560 may be highlighted or emphasized when paper group attributes 570 are displayed within user interface 120. Paper group attributes 570 also include brand attribute 512 having a value 514 of Big Print Color Copy. Thus, papers having the same brand attribute 512 are listed in first set of papers 416. The number of papers in first set of papers 416 is defined further by the remaining attributes.

Type attribute 532 may be included and having a value 534 of plain such that plain paper of brand attribute 512 is within first set of papers 416. Set count attribute 536 has a value 538 of 1 to further define the papers within first set of papers 416. Color attribute 540 also may be specified as having a value 542 of white so that white papers are included. Front coating attribute 544 has a value 546 of inkjet. Back coating attribute 548 has a value 550 also of inkjet. Texture attribute 552 may be specified as having a value 554 of smooth. Preprinted attribute 556 may have a value 558 of no. All papers within first set of papers 416 have these attributes, as set forth in their paper catalog entries or in data provided with the papers as they are entered within printing system 100.

Using the above attributes and values, first set of papers 416 may include papers within paper catalog 124 that are of the Big Print Color Copy brand, plain type, a set count of 1, a white color, front and back coating for inkjet, a smooth texture, and not preprinted. Other attributes are not included in paper group attributes 570 in that the papers in first set of papers 416 do not necessarily have those attributes or values. For example, papers within first set of papers 416 with paper group attributes 570 may have any weight.

It should be noted that the values disclosed above are examples of the type of data included for to differentiate the data for the attributes. Other data values may used for the attributes but are not listed here due to brevity. Further, the attributes may be changed for first paper 402, which then causes other papers to be updated based on aggregations disclosed herein. The papers in the groups or sets are the papers that use the same values for attributes that impact printing reproduction, especially color reproduction.

An example is shown below of a paper group aggregated based on an attribute and showing the different features associated with the paper group. This list may be what is shown in user interface 120.
[Brand Name] Color Copy-coated silk
135 gsm-50 μm-A4 (210×297 mm)
135 gsm-50 μm-A4 (210×297 mm)
135 gsm-50 μm-SRA3 R (320×450 mm)
170 gsm-50 μm-A4 (210×297 mm)
170 gsm-50 μm-A4 R (210×297 mm)
170 gsm-50 μm-SRA3 R (320×450 mm)
250 gsm-50 μm-A4 (210×297 mm)
250 gsm-50 μm-A4 R (210×297 mm)
250 gsm-50 μm-SRA3 R (320×450 mm)

Referring back to FIG. 4, other aggregations may take place beyond just first set of papers 416. For example, the disclosed embodiments may form a peer calibration group 422. Here, DFE 106 may mirror the aggregation used to manage calibrations and display a single entry for each peer calibration group. A peer calibration group is created for a set of papers that have calibrations using the same source calibration data, or calibrations that were printed using the same values for attributes that affect calibration curves, such as media and halftone.

First paper 402 may have a first calibration 408 associated with it in paper catalog 124. Other calibrations may be associated with first paper 402 but not shown here for brevity. First calibration 408 is generated using calibration source data 410. A calibration operation is performed at printing device 104 using calibration source data 410 to perform the calibration and generate the resources related to printing first paper 402 having certain print attributes, such as halftone or print condition. The operator may select first calibration 408 of first paper 402 to be exported.

In response, the disclosed embodiments also aggregate the papers in peer calibration group 422 for possible integrated resource management. Peer calibration group 422 includes a plurality of papers, including first paper 402. It also includes fourth paper 424. Fourth paper 424 is associated with a second calibration 426 according to paper catalog 124. Second calibration 426 also uses calibration source data 410. Peer calibration group 422 also includes fifth paper 427, which is associated with third calibration 428 according to paper catalog 124. Third calibration 428 also uses calibration source data 410.

Thus, peer calibration group 422 may be added to a list of items for integrated resource management along with first calibration 408. It should be noted that first paper 402 may be in several peer calibration groups as it is associated with multiple calibrations within paper catalog 124. Different calibration source data may be used for the different calibrations and used in different peer calibration groups.

The disclosed embodiments also mirror aggregation used to manage spot colors to display aggregated spot color definitions and adjustments. Thus, second set of papers 430 may be generated. If the operator wishes to export spot color 412 used by first paper 402, then second set of papers may be created from those papers also using spot color 412. Further, spot color 412 may include a spot color adjustment 414 that is also part of the colors resource being exported.

Based on spot color 412, DFE 106 may identify a set of papers to populate second set of papers 430. For example, sixth paper 432 of paper catalog 124 may include spot color 412, like first paper 402. Sixth paper 432 also may incorporate spot color adjustment 414, if applicable. Seventh paper 434 of paper catalog 124 also may include spot color 412 and is, therefore, added to second set of papers 430.

Depending on the resource of first paper 402 to be exported, paper groups are generated to provide further information for the operator to select to export. For example, the operator may want all papers that can meet the requirements for printing, such attributes, calibrations, or spot colors. In some embodiments, if first paper 402 is selected for export, then the disclosed embodiments may aggregate different sets of papers to provide options for exporting resources. The resource, such as paper catalog entry, attribute, calibration, or spot color may be highlighted to let the operator know what is being used to form the set of papers.

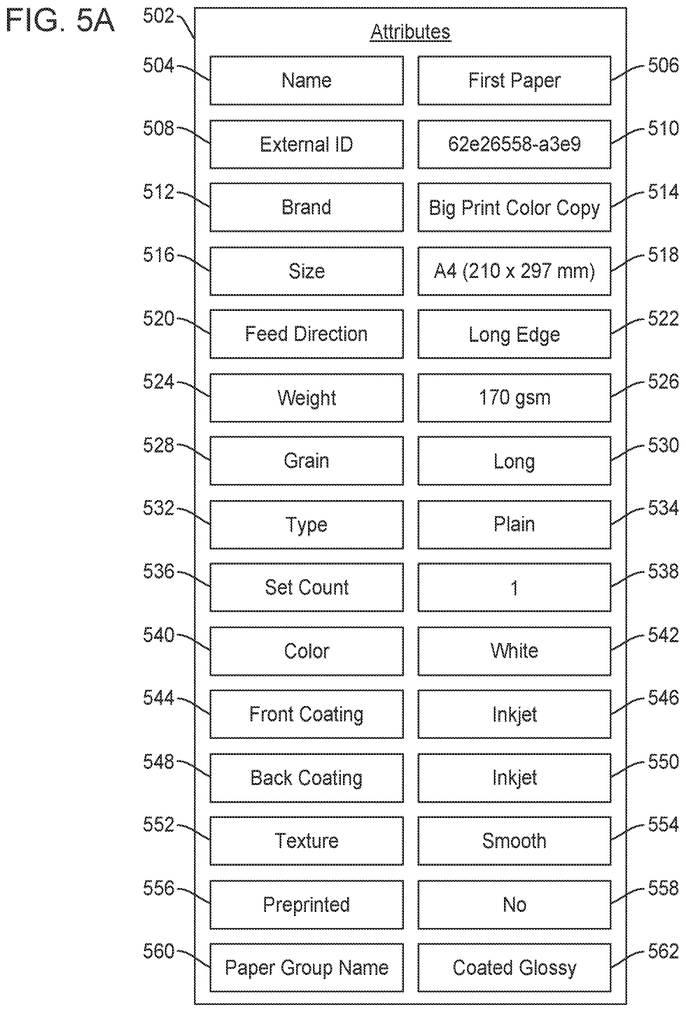

FIG. 6 depicts a flowchart 600 for aggregating related resources based on a paper catalog entry 302 according to the disclosed embodiments. Flowchart 600 may refer to FIGS. 1A-5 for illustrative purposes. Flowchart 600, however, is not limited to the embodiments disclosed by FIGS. 1A-5.

Step 602 executes by selecting a paper, such as first paper 402, from the plurality of papers available to print on printing device 104 or within printing system 100 to begin integrated resource management. Step 604 executes by determining a paper catalog entry 302 for first paper 402. In some embodiments, there may be multiple paper catalog entries 302 for first paper 402. Step 606 executes by selecting the paper catalog entry 302 for first paper 402 to manage within printing system 100. The operator may review paper catalog 124 and select paper catalog entry 302 for first paper 402.

Step 608 executes by determining calibrations that are associated with paper catalog entry 302 and first paper 402. For example, paper catalog entry 302 may include first calibration 408 along with additional calibrations. Referring to FIG. 3, paper catalog entry 302 includes calibration data 308A and 308B, so that there may be two calibrations to associate with first paper 402. Step 610 executes by displaying the calibrations 308A and 308B with paper catalog entry 302 along with first paper 402 and the paper catalog entry. This feature allows the operator to see which calibrations will be managed along with paper definitions. In other words, the operator may view what resources are being managed for first paper 402 based on its paper catalog entry 302.

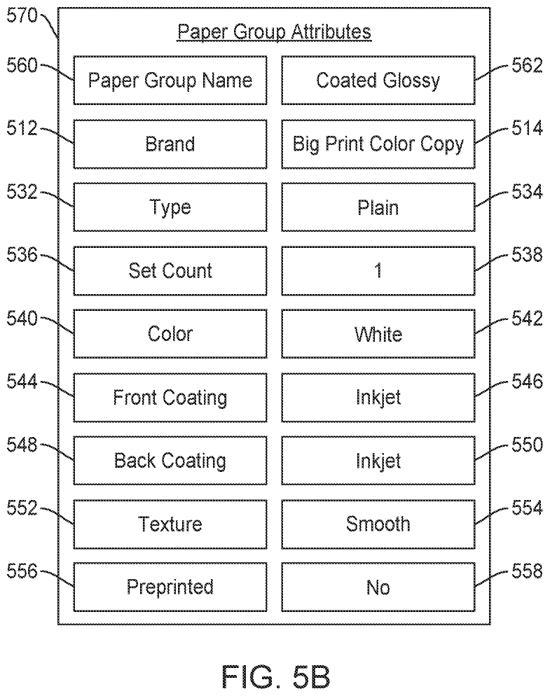

FIG. 7 depicts a flowchart 700 for aggregating related resources based on a calibration according to the disclosed embodiments. Flowchart 700 may refer to FIGS. 1A-6 for illustrative purposes. Flowchart 700, however, is not limited to the embodiments disclosed by FIGS. 1A-6.

Step 702 executes by selecting a calibration to export or import within printing system 100. For example, the operator may select first calibration 408 of first paper 402. Further, for example, first calibration 408 may correspond to calibration data 308A within paper catalog entry 302. Thus, the calibration is associated with a paper catalog entry 302 within paper catalog 124. Step 704 executes by determining which paper catalog entry 302 was used to create the calibration.

Step 706 executes by determining which papers relate to the calibrated paper. For example, first paper 402 is the calibrated paper for first calibration 408. The disclosed embodiments determine the papers related to first paper 402. In some embodiments, groups or sets of papers may be generated based on attributes in common with first paper 402, as disclosed above. For example, one or more attributes may be selected to define the groups or sets of papers. Step 708 executes by aggregating the papers related to first paper 402 based on its paper catalog entry 302 to form one or more groups or sets of papers.

Step 710 executes by determining related ICC profiles that are associated with the calibration. For example, first calibration 408 also may be calibration 308A in paper catalog entry 302 for first paper 402. ICC profile 310A is related to calibration 308A. The disclosed embodiments will determine ICC profile 310 should be grouped with the other resources and information for export or import. If the calibration being exported or imported is calibration 308B, then the disclosed embodiments would identify ICC profile 310B for being grouped with the aggregated papers.

Step 712 executes by determining one or more spot color adjustments that are associated with the selected calibration. For example, spot color 412 and spot color adjustment 414 may be associated with first calibration 408. Preferably, this fact is shown within paper catalog entry 302 for first paper 402. The disclosed embodiments will determine which base spot color definition and spot color aliases for spot color 412 should be aggregated along with spot color adjustment 414. For example, spot color 412 may relate to other data entries within printing device 104 for the defined color and the disclosed embodiments wants to make sure to aggregate these with spot color 412.

It is noted that step 712 may be executed as its own process. In other words, spot color 412 may be selected as the resource to be managed or updated. First calibration 408 may not be used to determine spot color 412. If so, then step 712 executes as its own process to aggregate spot colors and resources. For example, the disclosed embodiments will look for spot color aliases and spot color adjustments 414 that are associated with the selected spot color 412. The aggregated spot colors may be displayed in step 714 below.

Step 714 executes by displaying the aggregated groups or sets of papers, ICC profiles, and spot colors and spot color adjustments within user interface 120. The operator may review the related color printing resources associated with the selected calibration for management of the papers within the aggregated groups or sets within printing system 100.

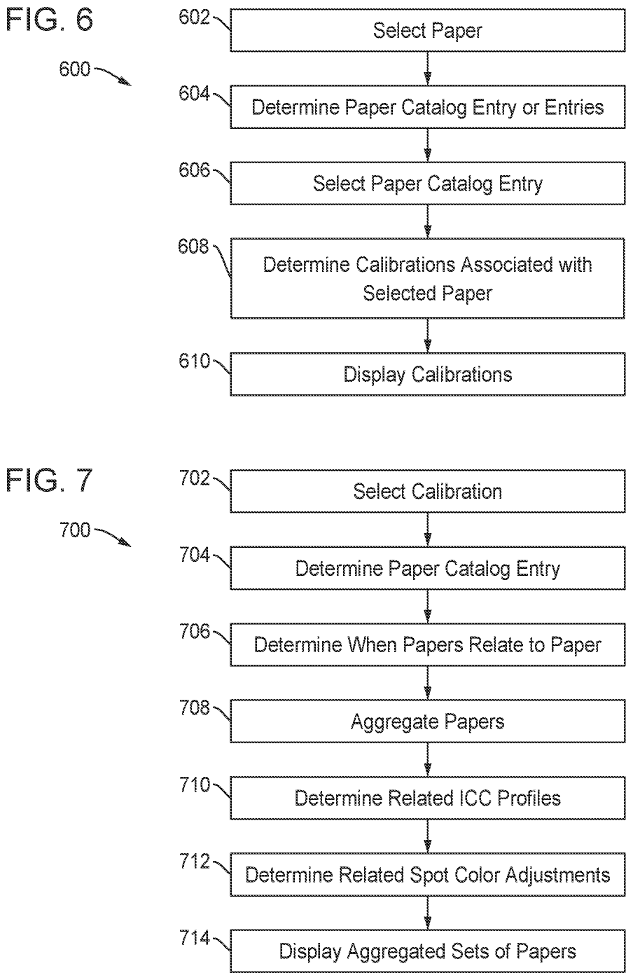

FIG. 8 depicts a flowchart 800 for aggregating related resources based on an ICC profile according to the disclosed embodiments. Flowchart 800 may refer to FIGS. 1A-7 for illustrative purposes. Flowchart 800, however, is not limited to the embodiments disclosed by FIGS. 1A-7.

Step 802 executes by selecting an ICC profile. For example, ICC profile 310A may be selected. Paper catalog entry 302 having ICC profile 310A may be associated with first paper 402. Step 804 executes by determining the calibration used to create the selected ICC profile. For example, the disclosed embodiments determine that calibration 308A is used to generate ICC profile 310A.

Step 806 executes by determining that the calibration used to create the ICC profile is part of a peer calibration group. For example, calibration 308A corresponds to first calibration 408. First calibration 408 is part of peer calibration group 422, which uses calibration source data 410 for at least one calibration for a set of papers aggregated within the group. First calibration 408 for first paper 402 means that the first paper is within peer calibration group 422 along with fourth paper 424 and fifth paper 427.

Step 808 executes by aggregating the papers within the peer calibration group. In some embodiments, papers within the peer calibration group may be further defined using one or more attributes of first paper 402 to form sub-sets of papers within peer calibration group 422. Step 810 executes by displaying the peer calibration group within user interface 120 along with the selected ICC profile. The operator may wish to manage the papers or the color printing resources for the papers aggregated within peer calibration group 422. The disclosed embodiments automatically define these groups and provides them to the operator based on the selected calibration or ICC profile.

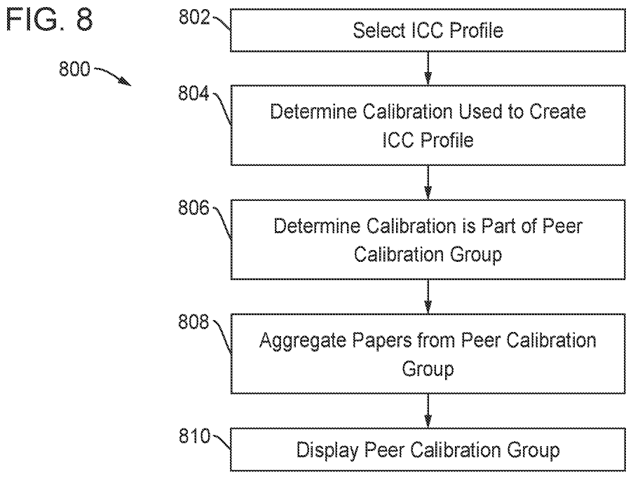

FIG. 9 depicts a flowchart 900 for aggregating resources according to the disclosed embodiments. Flowchart 900 may refer to FIGS. 1A-8 for illustrative purposes. Flowchart 900, however, is not limited to the embodiments disclosed by FIGS. 1A-8. The disclosed embodiments may crawl through resources to provide the operator with a complete set of resources. For example, the operator may export or import paper catalog 124.

Step 902 executes by selecting paper catalog 124 to export to or import from printing device 104. Step 904 executes by aggregating paper catalog entries 302 within paper catalog 124. The multiple paper catalog entries 302 may be treated as a single aggregated entry. Step 906 executes by determining calibrated paper catalog entries. Each paper catalog entry 302 may be analyzed to identify those that have calibrations associated with them. For example, if first paper 402 is associated with paper catalog entry 302 of FIG. 3, then it may be determined that first paper 402 has calibration 308A and calibration 308B associated with the entry.

Step 908 executes by aggregating all calibrations within the paper catalog entry for each calibrated paper. For example, calibrations 308A and 308B may be aggregated for first paper 402. Additional calibrations associated with paper catalog entry 302 for first paper 402 also may be aggregated.

Step 910 executes by determining associated peer calibration groups for the aggregated calibrations. Peer calibration groups are disclosed above. For example, peer calibration group 422 may be aggregated around calibration source data 410 such that papers having calibrations using the same calibration source data will be added to the group. There may be multiple peer calibration groups 422 for a given paper catalog entry 302 as the paper may include multiple calibrations. For example, referring to FIG. 3, paper catalog entry 302 include calibration 308A and 308B. Separate peer calibrations groups may be formed each calibration as they use different calibration source data. Thus, first paper 402 may be aggregated in two or more peer calibration groups.

Step 912 executes by aggregating ICC profiles created for any of the calibrations within the paper catalog entry. The disclosed embodiments determine if an ICC profile has been created for any of the calibrations. For example, referring to FIG. 3, if paper catalog entry 302 or first paper 402 is aggregated with the entry for paper catalog 124, then ICC profile 310A and ICC profile 310B will be aggregated with the other resources for management.

Step 914 executes by determining spot color adjustments associated with any of the calibrations aggregated above. For example, spot color 412 may be associated with calibration 308A of paper catalog entry 302 for first paper 402. If so, then the disclosed embodiments in step 916 will aggregate the spot color including the base spot color definition and spot color aliases associated with a spot color adjustment 414 for spot color 412. Further, the disclosed embodiments may manage spot color adjustments that are associated with paper catalog entries other than selected paper catalog entry 302.

Step 918 executes by identifying additional resources that may be aggregated or added to the information provided to the operator. For example, if spot color adjustments 414 for spot colors 412 are to be managed, then the disclosed embodiments will crawl back through the resources in paper catalog 124 to aggregate those paper catalog entries, calibrations, and the like.

In some embodiments, the operator may select calibrations to manage instead of paper catalog entries. If so, then the disclosed embodiments may execute the processes of flowchart 900 as disclosed above, except starting with each calibration instead of with a paper catalog entry 302. In this instance, however, the source resource is the calibration. Thus, step 904 is performed after selecting the calibration in that paper catalog entries 302 are aggregated based on the calibration. From there, the aggregated paper catalog entries form their own group.

Step 920 executes by displaying the entries generated above for paper catalog 124 and the aggregated groups and resources to the operator. The entries may be displayed within user interface 120. The aggregated entries may look like below:

### Paper Groups

1. Undefined—Paper Group Name
1A. weight—thickness—size (grain)—[attributes of the paper group]
2. First Brand—Paper Group Name
2A. weight—size (grain) [no defined thickness]
2B. weight—thickness—size (grain) [calibrated size, these sizes are calibrated]
2Bi. calibration name—halftone
3. Second Brand—Paper Group Name
3A. weight—thickness—size (grain) [calibrated size]
3Ai. calibration name—halftone—print condition
3Aia. ICC profile name [this paper's ICC profile for this calibration]
3B. weight—thickness—size (grain) [calibrated size with spot color adjustment]
3Bi calibration name—halftone—print condition
3Bia. ICC profile name [this paper's ICC profile for this calibration]
3Bib. Spot color name [spot color adjustment assigned to this paper/calibration]
   As can be appreciated, many paper groups and aggregated resources may be displayed.

Step 922 executes by selecting resources to manage or selecting attributes to manage. The operator may select which resources (paper catalog entries, calibrations, spot colors, ICC profiles) to manage. The disclosed embodiments will automatically link all resources using the above displayed tree. Alternatively, the operator may be given the option to not manage the linked resources. For example, the operator may remove resources as desired. Step 924 executes by storing the resources selected in a file that may be managed at a later time. The file may be stored within DFE 106 of printing device 104. Alternatively, the file may be stored at a linked device to printing device 104. The operator may send the file from DFE 106 to the desired location.

With regard to managing resources, the same actions may be taken as disclosed above in terms of aggregated resources for selection. When resources are managed, the disclosed embodiments may manage resources based on the dependencies to ensure all dependent resources are managed. The disclosed embodiments will provide a status for all resource types. The operator may be given the option to choose which resources to manage within printing system 100. This feature may be at the top level or at every level of the resource tree. Managed resources retain the original associations to ensure that these resources are used in the same manner in printing device 104 or printing system 100 as they are used in the source printing device or system.

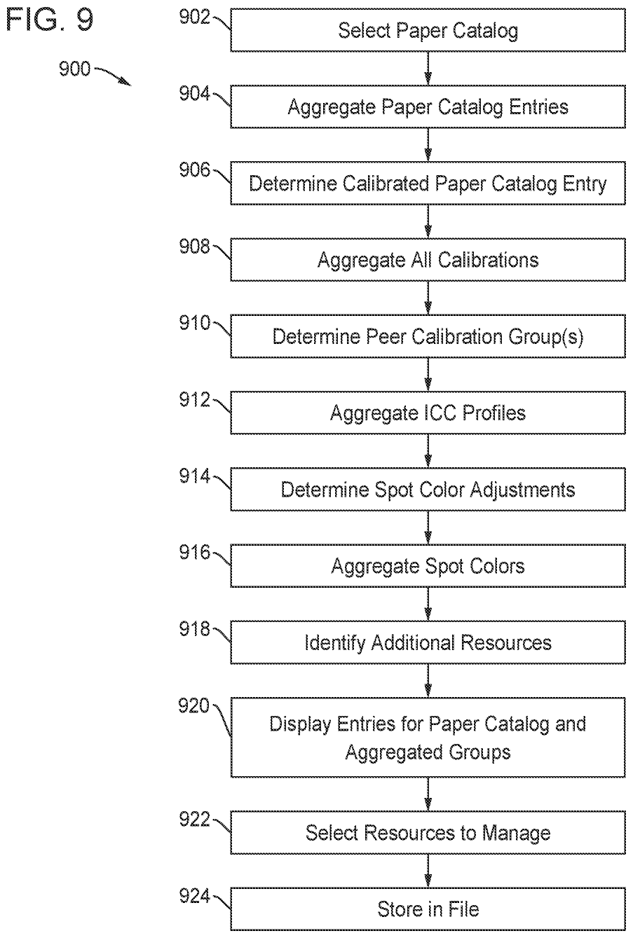

FIG. 10 depicts a flowchart 1000 for managing a first set of papers 416 using an attribute 404 according to the disclosed embodiments. Flowchart 1000 may refer to FIGS. 1A-9 for illustrative purposes. Flowchart 1000, however, is not limited to the embodiments disclosed in FIGS. 1A-9.

Step 1002 executes by determining a shared attribute 404 related to a printing operation for papers in paper catalog 124. As disclosed above, paper catalog 124 includes a plurality of papers for printing on printing device 104. Step 1004 executes by aggregating first set of papers 416 from the plurality of papers within paper catalog 124 based on attribute 404. The aggregation may be done using user interface 120, wherein the operator may select attribute 404 from a first paper 402 within paper catalog 124. First set of papers 416 may be aggregated so that it includes second paper 418 and third paper 420, each also having attribute 404. Thus, printing operations using first paper 402, second paper 418, and third paper 420 may implement attribute 404 when performing a print job.

Step 1006 executes by modifying first set of papers 416 according to a type of printing device 104. First set of papers 416 further may be limited based on the configuration of printing device 104. For example, printing device 104 may not print paper having a size of A4. Third paper 420 may include a value of A4 for the dimensions. Thus, first set of papers 416 is modified to drop third paper 420 from the set of available papers aggregated for integrated resource management. In another example, printing device 104 may be an inkjet printing device. Thus, all papers of any weight may be aggregated for the inkjet printing device. If printing device 104 is a toner device, then set of papers 416 may be modified based on weight ranges as these correspond with fuser temperature or paper transport speed, both of which impact color reproduction.

Step 1008 executes by editing a feature, or setting, of first set of papers 416. A setting applicable to the papers in first set of papers 416 may be updated or changed. Referring to FIG. 5B, paper group attributes 570 are shown. One of the attributes may be changed, or a value for an attribute, of first set of papers 416. Alternatively, a configuration setting for printing device 104 applicable to first set of papers 416 may be changes, such as a maximum number of pages that can be printed based on weight of papers within first set of papers 416. Other settings may be ink limits, weight and paper combinations, and the like. Finally, attribute 404 may be changed or any of the common attributes or their values.

Step 1010 executes by updating the paper catalog entries for the aggregated papers in first set of papers 416. Entries within paper catalog 124 may be updated with the edited feature, setting, or attribute that applies across all papers within the aggregated paper group. This update may be done without having to update each paper catalog entry individually. Thus, the disclosed embodiments provide integrated resource management of the papers of first set of papers 416. Step 1012 executes by specifying print ticket settings for print ticket 126 for a paper within first set of papers 416 using attribute 404. Print jobs generated for a paper using first set of papers 416 may automatically populate a print ticket setting with attribute 404.

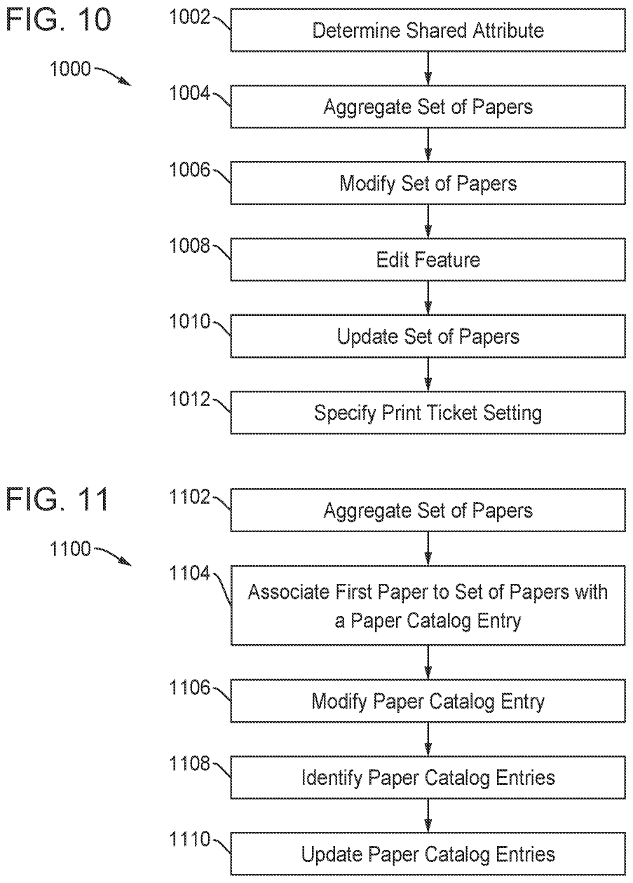

FIG. 11 depicts a flowchart 1100 for managing first set of papers 416 using a paper catalog entry according to the disclosed embodiments. Flowchart 1100 may refer to FIGS. 1A-10 for illustrative purposes. Flowchart 1100, however, may not be limited to the embodiments disclosed by FIGS. 1A-10.

Step 1102 executes by aggregating first set of papers 416 based on a shared attribute 404. Step 1102 is similar to step 1004 disclosed above. Step 1104 executes by associating first paper 402 of first set of papers 416 with a paper catalog entry 302 within paper catalog 124. In some embodiments, paper catalog 124 is stored at printing device 104. First paper 402 is a paper catalog entry within paper catalog 124. Step 1106 executes by modifying paper catalog entry 302 for first paper 402. For example, another attribute, setting, or feature applicable to first paper 402 may be changed. Alternatively, a printing resource, such as print condition 304, may be changed.

Step 1108 executes by identifying paper catalog entries 302 within paper catalog 124 corresponding to first set of papers 416. For example, second paper 418 and third paper 420 are within first set of papers 416. Paper catalog entries 302 for second paper 418 and third paper 420 are identified within paper catalog 124 based on their association with first paper 402 through the aggregated paper set.

Step 1110 executes by updating paper catalog entries 302 for the papers in first set of papers 416 with a modification for paper catalog entry 302 for first paper 402. For example, a color printing resource may be added for first paper 402 to modify its paper catalog entry 302. The color printing resource may be a calibration having calibration data 308A. Calibration data 308A may be the modification to paper catalog entry 302. Thus, paper catalog entries 302 for second paper 418 and third paper 420 may be updated with calibration data 308A. Using the print condition example, print condition 304 for first paper 402 may be changed from premium to economy based on new papers added to paper catalog. The print conditions for second paper 418 and third paper 420 also may be updated with the aggregated paper set. Thus, integrated resource management may occur.

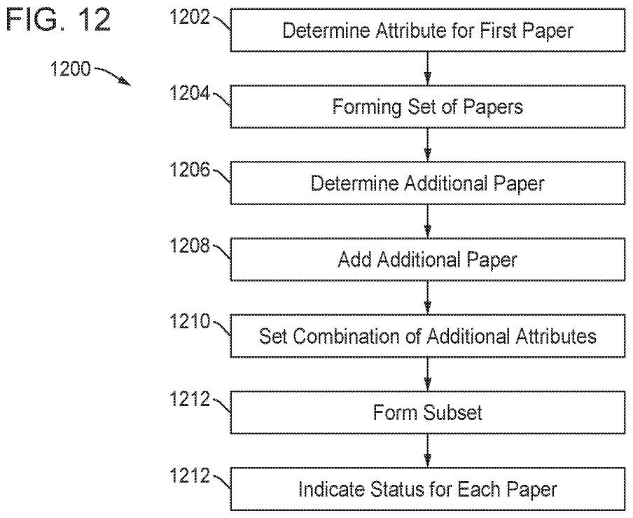

FIG. 12 depicts a flowchart 1200 for managing a subset of papers having additional attributes according to the disclosed embodiments. Flowchart 1200 may refer to FIGS. 1A-11 for illustrative purposes. Flowchart 1200, however, is not limited to the embodiments disclosed by FIGS. 1A-11.

Step 1202 executes by determining attribute 404 for first paper 402 in paper catalog 124. Referring to paper catalog entry 302, a paper may include several attributes. The operator may select one for first paper 402 from entries related to its paper catalog entry. Step 1204 executes by forming a first set of papers 416 having first paper 402 and attribute 404. The other papers in first set of papers 416 also include attribute 404. For example, second paper 418 also includes attribute 404.

Step 1206 executes by determining at least one additional paper within paper catalog 124 having attribute 404. In some embodiments, first set of papers 416 includes papers having paper catalog entries 302. Third paper 420 is within paper catalog 124 and also includes attribute 404. For example, third paper 420 may be modified to include attribute 404 or may be a new paper added to paper catalog 124. Third paper 420 may be considered a calibrated paper based on its inclusion within paper catalog 124. More than one paper may be added in this manner. Step 1208 executes by adding third paper 420 having attribute 404 to first set of papers 416 along with first paper 402 and second paper 418.

Step 1210 executes by setting a combination of additional attributes for first paper 402 and the at least one additional paper of first set of papers 416. As shown in FIG. 5A, a paper within paper catalog 124 may include multiple attributes. The disclosed embodiments may set a combination of these attributes for first paper 402 and third paper 420. In addition to attribute 404, one or more attributes 502 also may be in common for these papers. The disclosed embodiments may manage these further defined resources in an integrated manner, much like first set of papers 416.

Step 1212 executes by forming a subset of first set of papers 416 having the combination of additional attributes. For example, first paper 402 and third paper 420 may be within this subset, but second paper 418 is not. In addition to attribute 404, the subset may include at least one additional attribute in common between the papers within the subset. For example, attribute 404 may relate to size attribute 516 disclosed in FIG. 5A while an additional attribute may relate to texture attribute 552 such that first paper 402 and third paper 420 share the values for size attribute 516 and texture attribute 552. FIG. 5B discloses attributes for a paper group according to the disclosed embodiments.

Step 1214 may execute by indicating a status for each paper in the subset of papers. Thus, a status is provided for first paper 402 and third paper 420. This status may relate to the availability of the papers for use in printing operations on printing device 104. The status also may indicate whether color printing resources are available or up to date for the papers. The status may be represented by an attribute for the specific paper, such as second attribute 314 in paper catalog entry 302. The status also may indicate that color printing resources need to be updated or at least checked for the papers within the subset. A paper may have had its color printing resources modified and updated such that papers sharing the same attributes also should be updated or at least checked prior to being used in printing operations at printing device 104, which uses paper catalog 124.

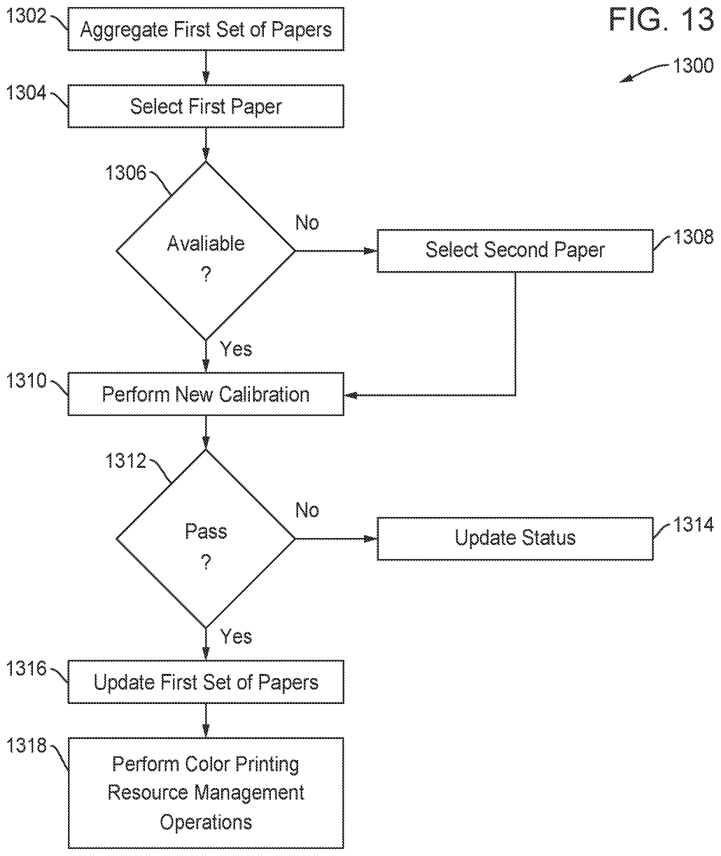

FIG. 13 depicts a flowchart 1300 for managing color printing resources within printing system 100 according to the disclosed embodiments. Flowchart 1300 may refer to FIGS. 1A-12 for illustrative purposes. Flowchart 1300, however, is not limited to the embodiments disclosed in FIGS. 1A-12.

Step 1302 executes by aggregating first set of paper 416 from a plurality of papers within paper catalog 124 based on attribute 404. Step 1302 may be similar to step 1004 disclosed above. An operator may select attribute 404 for aggregating using user interface 120. Step 1304 executes by selecting first paper 402 of first set of papers 416. First paper 402 includes an existing calibration, such as first calibration 408. Paper catalog entry 302 for first paper 402 may indicate this relationship. The disclosed embodiments may present only calibrated papers within paper catalog 124 so that the operator does not perform an operation on an uncalibrated paper. In some embodiments, the disclosed embodiments may present a list of calibrations to the operator so as to select a calibration. The disclosed embodiments then apply the correct paper settings.

Step 1306 executes by determining whether first paper 402 is available for a new calibration. For example, first paper 402 may not be currently loaded onto printing device 104, or some other issue may prevent a new calibration being performed for the paper. If no, then step 1308 executes by selecting a second paper, such as second paper 418, for the new calibration. The disclosed embodiments may automatically replace any existing calibrations so that one calibration is available for first set of papers 416. Flowchart 1300 then proceeds to step 1310 to resume operations. For the remaining disclosure of flowchart 1300, first paper 402 will be used in the disclosure but second paper 418 selected in step 1308 may be used instead.

If step 1306 is yes, then step 1310 executes by performing a new calibration for first paper 402. The new calibration may be performed at printing device 104, so as to generate results for first paper 402 for color printing operations at the printing device. Further, first paper 402 may use calibration source data 410. Step 1312 executes by determining whether the new calibration for first paper 402 passed. If no, then step 1314 executes by updating a status for an ICC profile, such as ICC profile 310A or 310B, associated with the existing calibration, such as first calibration 408. A status for a spot color adjustment, such as spot color adjustment 414 for spot color 412, associated with the existing calibration may be updated. Further, a selected paper within first set of papers 416 also may have a status for one or more of its calibrations updated with a change in status for an ICC profile or spot color adjustment.

If step 1312 is yes, then step 1316 executes by updating first set of papers 416 having first paper 402 with the new calibration. The new calibration is shared between all the papers within first set of papers 416. This feature may eliminate manual association between papers and calibrations because the calibration understands the paper aggregation. The disclosed embodiments may manage calibrations so it is not possible for the operator to misconfigure the color printing resources in printing system 100.

Step 1318 executes by performing color printing resource management operations on the integrated resources based on the new calibration being shared with first set of papers 416. As can be appreciated, an updated calibration may impact other color printing resources for papers, such as ICC profiles and spot color adjustments for papers within the aggregated set of papers.

For example, an existing calibration for a selected paper of first set of papers 416 may be deleted based on the new calibration shared within the set. For example, second paper 418 may be selected. The operator may review the papers within first set of papers 416 to select papers to replace their existing calibrations with the new one. The existing calibrations are deleted from paper catalog 124. Further, an ICC profile associated with the existing calibration of the selected paper also may be deleted. For example, referring to FIG. 3, halftone 306A of paper catalog entry 302 may be updated using the new calibration generated for first paper 402. Calibration 308A may be deleted. ICC profile 310A, associated with calibration 308A, also may be deleted automatically so as to update paper catalog 124 based on the aggregated set of papers. Further, a spot color adjustment, such as spot color adjustment 414, for the selected paper also may be deleted.

In other embodiments, the existing calibration may be replaced for a selected paper within first set of papers 416 with the new calibration. For example, second paper 418 may be selected. Second paper 418 may include an existing calibration, such as calibration 308A along with an associated ICC profile 310A. The new calibration from first paper 402 is compared to existing calibration 308A to determine whether the new calibration is substantially similar to the existing calibration, the new calibration is not substantially similar to the existing calibration, or the new calibration is very different from the existing calibration.

Depending on the comparison, certain operations may be executed. If the new calibration is substantially similar to the existing one, then remapping an association between the ICC profile to use the new calibration would be configured. For example, ICC profile 310A would be remapped to use the new calibration instead of existing calibration 308A. Existing calibration 308A may be deleted. If the new calibration is not substantially similar to the existing calibration, then the disclosed embodiments may check whether it is within a specified threshold of the existing calibration. If so, then the disclosed embodiments may update a status for the ICC profile to include a warning to recreate the ICC profile. An example threshold may be within 10% of the existing calibration. If the new calibration is very different from the existing calibration, such as outside the threshold, then the disclosed embodiments may delete the associated ICC profile.

These same operations may be performed for any spot color adjustments associated with the existing calibration. For example, a spot color adjustment 414 may be associated with halftone 306A of paper catalog entry 302 for first paper 402 or second paper 412. Based on the comparison of the new calibration and the existing calibration, such as calibration 308A, the disclosed embodiments remap an association between the spot color adjustment and the new calibration, update a status for the spot color adjustment to include a warning to readjust the spot color adjustment, or deletes the spot color adjustment based on the comparison, similar to the operations for ICC profiles disclosed above.

Thus, according to the disclosed embodiments, integrated resources may be managed using these processes in a consistent and somewhat automatic manner without the need to manually enter updates within paper catalog 124. Papers are aggregated and management of color resources impacted by an update to a paper within the aggregated set of papers is done seamlessly.

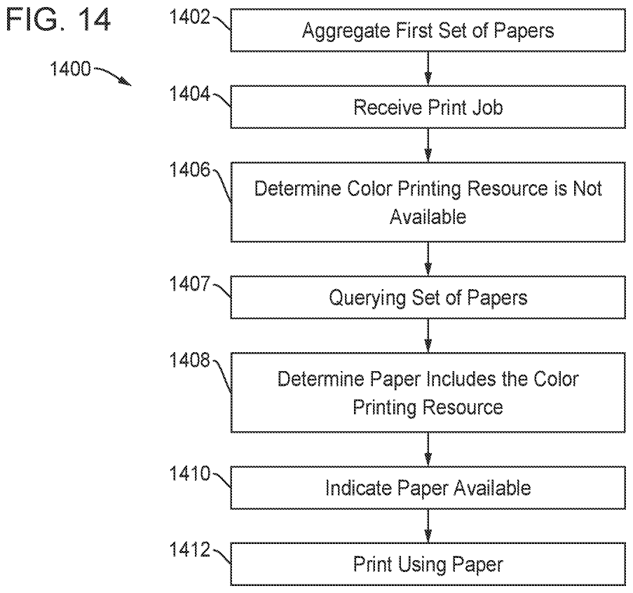

FIG. 14 depicts a flowchart 1400 for using integrated resources to determine a second paper for printing operations according to the disclosed embodiments. Flowchart 1400 may refer to FIGS. 1A-13 for illustrative purposes. Flowchart 1400, however, is not limited to the embodiments disclosed by FIGS. 1A-13.

Step 1402 executes by aggregating first set of papers 416 based on attribute 404, similar to step 1004 disclosed above. Step 1404 executes by receiving print job 103 at printing device 104 or within printing system 100. Print job 103 may specify first paper 402 in print ticket 126. First paper 402 is one of the papers aggregated in first set of papers 416 for integrated resource management.

Step 1406 executes by determining a color printing resource for first paper 402 is not available. Color printing resources include a calibration, a paper catalog entry, and ICC profile, a spot color adjustment, and the like. For example, a color printing resource may be updated as disclosed above, and a warning status is attached to the color printing resource that needs to be resolved before first paper 402 can be used in printing operations. Based on this situation, first paper 402 is not available for printing the document for print job 103.

Step 1407 executes by querying first set of papers 416 for papers being managed according to the disclosed embodiments. The papers in the aggregated set includes at least attribute 404 in common with first paper 402 as well as additional attributes. Further, as disclosed above, a subset of papers may be generated of papers having a combination of attributes in common with first paper 402. Attributes specified in print ticket 126 may be used in querying the papers in the set of papers.

Step 1408 executes by determining a second paper 418 of first set of papers 416 includes the color printing resource needed to complete the printing operations for print job 103. The disclosed embodiments may select second paper 418 using integrated resource management. Alternatively, the operator may be presented a list of papers from first set of papers 416 and selects one. Step 1410 executes by indicating second paper 418 is available to complete print job 103 along with the indicated color printing resource. The disclosed embodiments may highlight this feature in user interface 120. Step 1412 executes by printing print job 103 using second paper 418.

For example, first paper 402 may include a print condition 304 halftone 306A that includes ICC profile 310A. An update to calibration 308A using the integrated resource management operations disclosed above may set a status for ICC profile 310A as needing attention. Using the embodiments disclosed in flowchart 1400, it may be determined that second paper 418 includes an ICC profile 310A for its halftone 306A of the print condition 304 so that it can color print a document using these parameters. Thus, the disclosed embodiments allow the operator to manage printing operations without delays or a change in the color printing operations.

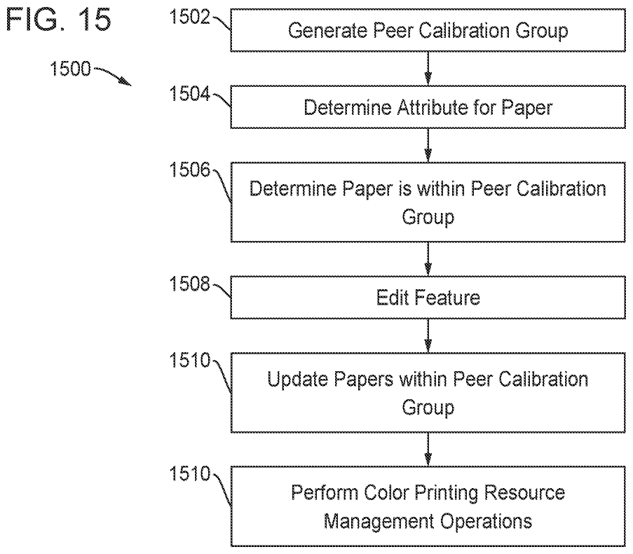

FIG. 15 depicts a flowchart 1500 for integrated resource management using peer calibration groups according to the disclosed embodiments. Flowchart 1500 may refer to FIGS. 1A-14 for illustrative purposes. Flowchart 1500, however, is not limited to the embodiments disclosed by FIGS. 1A-14.

Step 1502 executes by generating peer calibration group 422 based on calibration source data 410 as used for a calibration for papers within the group. Referring to FIG. 4, peer calibration group 422 includes first paper 402, fourth paper 424, and fifth paper 427. Each paper includes at least one calibration having the same calibration source data, or calibration source data 410. For example, first paper 402 includes first calibration 408 having calibration source data 410, fourth paper 424 includes second calibration 426 having calibration source data 410, and fifth paper 427 includes third calibration 428 having calibration source data 410.

As disclosed above, peer calibration group 422 may be similar to first set of papers 416, except it is aggregated by the shared calibration source data. Peer calibration group 422, however, may be managed much the same way as first set of papers 416.

Step 1504 executes by determining attribute 404 for first paper 402 of papers within paper catalog 124. As noted above, first paper 402 also includes first calibration 408 having calibration source data 410, which places it within peer calibration group 422. Step 1506 executes by determining first paper 402 is within peer calibration group 422 along with fourth paper 424 and fifth paper 427.

Step 1508 executes by editing a feature of first paper 402 of peer calibration group 422. Step 1508 is similar to step 1008 disclosed above. Step 1510 executes by updating papers within peer calibration group 422 with the edited feature. Step 1510 is similar to step 1010 disclosed above, except the update occurs to fourth paper 424 and fifth paper 427 in peer calibration group 422 instead of second paper 418 and third paper 420 of first set of papers 416.

Step 1512 executes by performing color printing resource management operations based on any modifications or updates to color printing resources in step 1508 or 1510. Step 1512 is similar to step 1318 disclosed above. The disclosed embodiments may perform the same operations as disclosed above, except within peer calibration group 422. Peer calibration groups allow the disclosed embodiments to perform integrated resource management on papers within paper catalog 124.

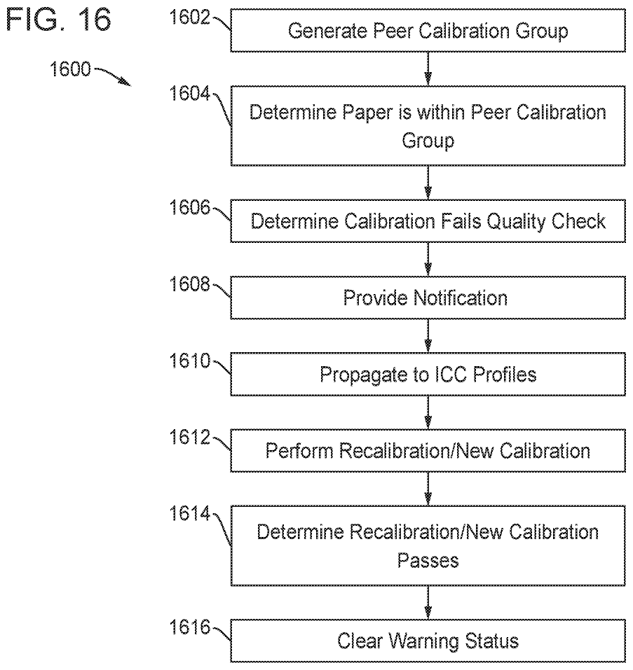

FIG. 16 depicts a flowchart 1600 for handling a failed calibration for a paper within peer calibration group 422 according to the disclosed embodiments. Flowchart 1600 may refer to FIGS. 1A-15 for illustrative purposes. Flowchart 1600, however, is not limited to the embodiments disclosed by FIGS. 1A-15.

Step 1602 executes by generating peer calibration group 422 based on calibration source data 410 as used for a calibration for papers within the group. Step 1602 is similar to step 1502 disclosed above. Step 1604 executes by determining first paper 402 is within peer calibration group 422 along with fourth paper 424 and fifth paper 427. Step 1604 is similar to step 1506 disclosed above.

Step 1606 executes by determining the calibration using calibration source data 410 applicable to first paper 402 fails a quality check. Quality checks may be performed using papers within paper catalog 124 at printing device 104 to make sure color printing operations are still meeting requirements related to the print condition. For example, if print condition 304 for paper catalog entry 302 for first paper 402 is premium, then print jobs having this print condition should print at a premium level of quality. Failure to do so may result in printed documents that do not meet the standards of the print condition. Thus, quality checks make sure the level for the print condition is being met.

Step 1608 executes by providing a notification to the other papers within peer calibration group 422. This notification may be a warning status for calibrations using calibration source data 410 within the peer calibration group. In some instances, use of these papers may be prevented within printing system 100 at printing device 104. Alternatively, a warning status is placed on the respective paper catalog entries for the papers within peer calibration group 422. For example, a notification of the warning status is provided for fourth paper 424 and fifth paper 427 for those print conditions or printing operations that use calibration source data 410.

Step 1610 executes by propagating the warning status to an ICC profile linked to the calibration of the plurality of papers. For example, second calibration 426 using calibration source data 410 for fourth paper 424 may be linked to an ICC profile for color printing operations. The disclosed embodiments propagate the warning status to this ICC profile to alert an operator that use of the ICC profile may be problematic. Flowchart 1600 may proceed to step 1612.

Step 1612 executes by performing a recalibration of first paper 402 based on the failed quality check. Alternatively, the disclosed embodiments may perform a new calibration on a different paper within peer calibration group 422, such as fourth paper 424. The recalibration or new calibration may be done to provide new calibration source data for the calibrations using the data within peer calibration group 422.

Step 1614 executes by determining the recalibration for first paper 402 passes the quality check. Alternatively, the disclosed embodiments may determine that the new calibration for fourth paper 424 may pass the quality check. The relationship of peer calibration group 422 may be used to update the status of the papers within the group using the calibration source data for their own calibrations.

Step 1616 executes by clearing the warning status applicable to those papers impacted by the failed calibration if those papers having lower TRC values than the TRC values for the recalibration of first paper 402. TRCs include curves to adjust color printing operations. If the values for a TRC is lower than those of the recalibration, then printing device 104 should operate within the desired parameters for that paper using the recalibration. Alternatively, if a new calibration is performed for fourth paper 424, the warning status is cleared for those papers having TRC values lower than those of the new calibration.

According to the disclosed embodiments, a failed quality check for a calibration may be used to update the statuses of papers within the peer calibration group. Further, the integrated resource management operations disclosed above may be used to resolve any issues associated with the failed calibration and to update those papers with the new calibration source data, if applicable. In some embodiments, peer calibration group 422 may be created by aggregating papers having print conditions using calibration source data 410, instead of using calibrations. The aggregated papers may be managed as disclosed above.

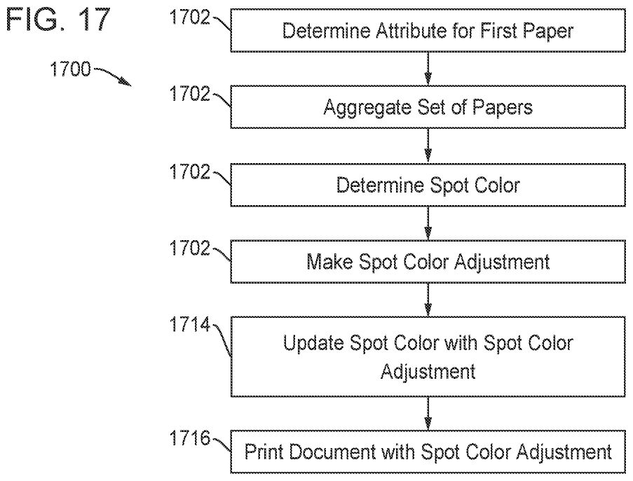

FIG. 17 depicts a flowchart 1700 for integrated resource management based on a spot color adjustment 414 according to the disclosed embodiments. Flowchart 1700 may refer to FIGS. 1A-16 for illustrative purposes. Flowchart 1700, however, is not limited to the embodiments disclosed by FIGS. 1A-16.

Step 1702 executes by determining an attribute for first paper 402 of a plurality of papers available to print at printing device 104. Step 1702 is similar to step 1202 disclosed above. First paper 402 includes first calibration 408. First paper 402 also may include spot color 412.

Step 1704 executes by aggregating second set of papers 430 based on the attribute. The attribute to aggregate second set of papers 430 may be similar the first set of papers 416 in using attribute 404. Alternatively, another attribute may be used so that the papers within second set of papers 430 differs from first set of papers 416. For example, second set of papers 430 may include sixth paper 432 and seventh paper 434. In some embodiments, second set of papers 430 may be a subset of first set of papers 416 based on additional parameters.

Paper groups also may be aggregated according to other criteria besides attributes. For example, second set of papers 430 may be aggregated according a print condition for first paper 402, sixth paper 432, and seventh paper 434. As disclosed above, the print condition may be a resource within a paper catalog entry 302 related to a quality of the print job, such as standard, premium, business, economy, low cost, and the like. Thus, the disclosed embodiments may integrate resource management centered around aggregated papers having the same print condition as first paper 402.

Paper groups also may be aggregated according to a project using second set of papers 430. For example, first paper 402 may have a common attribute with sixth paper 432 and seventh paper 434. That common attribute may be a project specified to be printed at printing device 104. The dimensions for first paper 402, sixth paper 432, and seventh paper 434 may differ for the project. Alternatively, the finishes may differ, such that first paper 402 uses a glossy finish for the project and the other papers do not. Integrated resource management operations may be performed as disclosed above, but using the project as the center point for the aggregation and management of the papers.

Paper groups also may be aggregated according to a customer identification that uses second set of papers 430 at printing device 104. Much like using the project as aggregation parameter or attribute, the customer identification for a specific customer may be used for different papers in the ways specified for the customer. Papers within the aggregated set of papers may have different attributes but they are used for the specific customer in that changes to these papers may be managed as integrated resources.

These aggregated groups of papers may be especially important when it comes to a spot color used by a common print condition, project, or customer identification. The spot color may be defined for these groups to print the spot color across different papers. Thus, any adjustments to the spot color also may be managed as an integrated resource.

Step 1706 executes by determining spot color 412 associated with first calibration 408 of first paper 402. Spot color 412 also is printable at printing device 104. Spot color 412 also may be applicable to the aggregated papers of second set of papers 430. Step 1708 executes by making spot color adjustment 414 for spot color 412. Spot color adjustment 414 may be made to have the desired color for spot color 412 reproduced at printing device 104. In some embodiments, spot color adjustment 414 may be generated with first calibration 408 is generated for first paper 402.

Step 1710 executes by updating spot color 412 for second set of papers 430 with spot color adjustment 414. Sixth paper 432 and seventh paper 434 include spot color 412. After spot color adjustment 414 is made for first paper 402, the disclosed embodiments use integrated resource management to update spot color 412 at sixth paper 432 and seventh paper 434 with spot color adjustment 414. This feature allows updates to happen without the need for the operator to update spot colors at each paper. In some embodiments, the operator may be prompted to update the spot colors in second set of papers 430 with the spot color adjustments within paper catalog 124. Step 1712 executes by printing a document using one of the papers of second set of papers 430 with spot color 412 having spot color adjustment 414.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing color printing resources within a printing system, the method comprising:
determining a shared attribute related to color reproduction of a plurality of papers in a paper catalog;
aggregating a set of papers from the plurality of papers within the paper catalog based on the attribute through a user interface;
selecting a first paper of the set of papers, wherein the first paper is calibrated by an earlier calibration;
performing a new calibration using the first paper; and
updating the set of papers having the first paper with the new calibration.

2. The method of claim 1, wherein updating the set of papers includes replacing an existing calibration for each of the set of papers.

3. The method of claim 1, further comprising
determining the first paper is not available for the new calibration;
selecting a second paper of the set of papers for the new calibration; and
updating the set of papers having the first paper and the second paper with the new calibration.

4. The method of claim 1, further comprising
deleting an existing calibration for a selected paper of the set of papers, wherein the selected paper is within the paper catalog; and
deleting an ICC profile associated with the existing calibration for the selected paper from the paper catalog.

5. The method of claim 1, further comprising
determining that the new calibration failed; and
updating a status for an ICC profile associated with a selected paper of the set of papers that the ICC profile is invalid.

6. The method of claim 1, further comprising
replacing an existing calibration for a selected paper within the set of papers with the new calibration, wherein the selected paper is associated with an ICC profile;
comparing the existing calibration with the new calibration; and
based on the comparison,
remapping an association between the ICC profile to use the new calibration,
updating a status for the ICC profile to include a warning to recreate the ICC profile, or
deleting the ICC profile.

7. The method of claim 1, wherein the first paper includes a spot color adjustment.

8. The method of claim 7, further comprising preventing updating a selected paper of the set of papers with the new calibration if the selected paper does not have the spot color adjustment.

9. The method of claim 1, further comprising
deleting an existing calibration for a selected paper within the set of papers; and
deleting a spot color adjustment associated with the existing calibration for the selected paper.

10. The method of claim 1, further comprising
determining that the new calibration failed; and
updating a status for a spot color adjustment associated with a selected paper of the set of papers that the spot color adjustment is invalid.

11. The method of claim 1, further comprising
replacing an existing calibration for a selected paper within the set of papers with the new calibration, wherein the paper is associated with a spot color adjustment;
comparing the existing calibration with the new calibration; and
based on the comparison,
remapping an association between the spot color adjustment and the new calibration,
updating a status for the spot color adjustment to include a warning to readjust the spot color adjustment, or
deleting the spot color adjustment.

12. A method for managing color printing resources, the method comprising:
determining a shared attribute related to color reproduction of a plurality of papers in a paper catalog;
aggregating a set of papers from the plurality of papers within the paper catalog based on the attribute through a user interface;
selecting a first paper of the set of papers, wherein the first paper is calibrated by an earlier calibration;
performing a new calibration using the first paper;
updating at least one paper of the set of papers having the first paper with the new calibration; and
deleting an existing calibration for a selected paper of the set of papers, wherein the selected paper is within the paper catalog.

13. The method of claim 12, further comprising deleting an ICC profile associated with the existing calibration for the selected paper from the paper catalog.

14. The method of claim 12, wherein updating at least one paper of the set of papers includes updating at least one paper having a print condition of the first paper.

15. The method of claim 12, wherein updating at least one paper of the set of papers includes updating at least one paper in a project with the first paper.

16. The method of claim 12, further comprising modifying a setting for the first paper of the set of papers.

17. The method of claim 16, further comprising updating the setting for each paper of the set of papers.

18. The method of claim 12, further comprising providing a warning for each paper of the set of papers that the existing calibration is deleted.

19. A method for managing printing operations, the method comprising:
determining a shared attribute for a plurality of papers available for printing at a printing device;
aggregating a set of papers from the plurality of papers based on the shared attribute;
receiving a print job at the printing device, wherein the print job specifies a first paper of the set of papers;
determining a color printing resource is not available at the printing device;
determining a second paper of the set of papers has the color printing resource; and
indicating the second paper is available for the print job along with indicating the color printing resource.

20. The method of claim 19, wherein the color resource is a calibration, a paper catalog entry, an ICC profile, or a spot color adjustment.
